(19) United States
(12) Patent Application Publication
(10) Pub. No.: US 2008/0150952 A1
(43) Pub. Date: Jun. 26, 2008

(54) Control apparatus, terminal apparatus, display system, and display method

(75) Inventor: Shohji Koarai, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/998,252

(22) Filed: Nov. 29, 2007

(30) Foreign Application Priority Data
Nov. 30, 2006 (JP) 2006-323841

(51) Int. Cl. G09G 5/39

(52) U.S. Cl. 345/531

(57) ABSTRACT

A control apparatus communicably connected to a multifunctional apparatus is provided with a cooperation module that acquires HTML data of an online Web page from a Web server and creates image data by converting the acquired HTML data into data displayable by an operation panel of the multifunctional apparatus. Then, the screen data created by the cooperation module is transmitted from the control apparatus to the multifunctional apparatus, and then is displayed by the operation panel. This makes it possible to cause the operation panel of the multifunctional apparatus to appropriately display online page information.

This Nonprovisional application claims priority under 35 U.S.C. § 119(a) on Patent Application No. 323841/2006 filed in Japan on Nov. 30, 2006, the entire contents of which are hereby incorporated by reference.

### FIELD OF THE INVENTION

The present invention relates to a display system for causing a display section of a terminal apparatus to display image data transmitted from a control apparatus to the terminal apparatus, a display method for causing a display section of a terminal apparatus to display image data transmitted from a control apparatus to the terminal apparatus, a control apparatus of the display system, and a terminal apparatus of the display system.

### BACKGROUND OF THE INVENTION

Conventionally, there have been developed a technique for causing a display screen of a terminal apparatus to display online image data.

For example, Japanese Unexamined Patent Application Publication No. 334674/2004 (Tokukai 2004-334674; published on Nov. 25, 2004) discloses a format conversion server which, in causing a display-equipped terminal (e.g., a portable terminal such as a portable phone or a PDA mobile terminal; or a household electrical appliance such as a fax machine or a refrigerator) to display online image data, converts the image data into a format displayable by a display of the terminal.

However, in causing a display device of a terminal apparatus to display an online image, the conventional technique may cause deterioration in visibility and user-friendliness, or may be slow in making a transition from one display screen to another.

For example, in cases where the online image contains an operation button, the conversion of the image into such a format and size that the image can be displayed by the terminal apparatus may cause such a large reduction in size of the operation button as to make it difficult to view and/or select the operation button.

Further, in cases where the online image contains link information, the link information may not be reflected in the image when the image is displayed by the terminal apparatus. This may make it impossible to browse online pages and/or to reproduce a plurality of linked images.

### SUMMARY OF THE INVENTION

The present invention has been made in view of the foregoing problems, and it is an object of the present invention to cause a display section of a terminal apparatus to appropriately display online page information.

In order to solve the foregoing problems, a control apparatus of the present invention is a control apparatus, including transmitting means for transmitting screen data to a terminal apparatus communicably connected to the control apparatus, which causes a display section of the terminal apparatus to display the screen data, the control apparatus including: data acquisition means for acquiring, from a server apparatus connected to a network, HTML data of a page available through the network; and screen data creating means for creating the screen data by converting the HTML data into data displayable by the display section.

Further, a display system of the present invention is a display system having (i) a terminal apparatus that includes a display section and (ii) a control apparatus that transmits screen data to the terminal apparatus and causes the display section of the terminal apparatus to display the transmitted screen data, the control apparatus including: data acquisition means for acquiring, from a server apparatus connected to a network, HTML data of a page available through the network; and screen data creating means for creating the screen data by converting the HTML data into data displayable by the display section, the terminal apparatus including receiving means for receiving the screen data transmitted from the control apparatus, the terminal apparatus causing the display section to display the received screen data.

Further, a display method of the present invention is a display method for use in a display system, having (i) a terminal apparatus that includes a display section and (ii) a control apparatus communicably connected to the terminal apparatus, which causes the display section to display screen data transmitted from the control apparatus to the terminal apparatus, the display method including: a data acquisition step in which the control apparatus acquires, from a server apparatus connected to a network, HTML data of a page available through the network; a screen data creating step in which the control apparatus creates the screen data by converting the HTML data into data displayable by the display section; a transmitting step in which the control apparatus transmits the created screen data to the terminal apparatus; a receiving step in which the terminal apparatus receives the screen data transmitted from the control apparatus; and a display step in which the terminal apparatus causes the display section to display the received screen data.

According to the foregoing arrangement, the data acquisition means acquires, from the server apparatus connected to the network, the HTML data of the page available through the network, and the screen data creating means creates the screen data by converting the HTML data into data displayable by the display section. This enables the display section of the terminal apparatus to appropriately display the online page information. For example, even in cases where a page to be displayed by the display section of the terminal apparatus is described by a method other than HTML or where the amount of information displayable by the display section of the terminal apparatus is smaller than the amount of HTML data stored in the server apparatus, it is possible to cause the display section of the terminal apparatus to display the online page information or part of the online page information.

Further, a terminal apparatus of the present invention is a terminal apparatus including (i) receiving means for receiving screen data transmitted from a control apparatus and (ii) a display section for displaying the screen data, the terminal apparatus including: accepting means for accepting an instruction to select a part image contained in a display screen displaying the screen data; and transmitting means for transmitting, to the control apparatus, information for specifying the selected part image.

The control apparatus prestores, in a screen data storage section, general-purpose screen data for the display section of the terminal apparatus to display. Moreover, the screen data creating means creates, as the screen data, an image obtained by pasting, on a part image contained in the general-purpose screen data or in a place adjacent to the part image contained in the general-purpose screen data, at least a part of a character string corresponding to the character string information contained in the link information extracted by the extracting means.

With this, for example, in cases where a reduction of the size of an online page image in accordance with the size of the display section of the terminal apparatus makes it difficult for a user of the terminal apparatus to perform an operation of selecting link information, an operation of selecting the part mage displayed by the display section of the terminal apparatus can be appropriately performed by the user by appropriately setting the size of the part image of the general-purpose screen data.

Further, when the accepting means of the terminal apparatus accepts an instruction to select the part image contained in the display screen displaying the screen data, the transmitting means of the terminal apparatus transmits, to the control apparatus, the information for specifying the selected part image. In the control apparatus, the part image and linked information contained in the link information are stored in the screen data storage section so as to be associated with each other. Therefore, when the information specifying the selected part image is accepted from the terminal apparatus, it is possible to specify linked information corresponding to the part information.

Therefore, by performing an operation of selecting, with use of the display section of the terminal apparatus, a part image corresponding to desired link information, the user can make a transition in display state to a display screen corresponding to the desired link information. Further, a process of tracking back online, e.g., pages available through the Internet or a plurality of linked images stored in a server apparatus can be realized with use of the display section of the terminal apparatus.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is an explanatory diagram showing an example of a process of creating, in a control apparatus according to an embodiment of the present invention, screen data by which an operation panel of a multifunctional apparatus displays a screen corresponding to a web page.

FIG. 2 is a diagram showing a structure of an image forming system according to an embodiment of the present invention.

FIG. 3 is an enlarged view of an operation section of the multifunctional apparatus.

FIG. 4 is a block diagram showing a structure of the control apparatus according to the present embodiment.

FIG. 5 is a diagram showing an example of a pressed button-processing content table provided in an information accepting section of the control apparatus.

FIG. 6 is a diagram showing an example of a processing request-processing content table provided in the information accepting section of the control apparatus.

FIG. 7 is a block diagram showing a structure of a multifunctional apparatus according to an embodiment of the present invention.

FIG. 8 is a diagram showing an example of URL registration information that is stored in a UI service layer of the multifunctional apparatus.

FIG. 9 is a diagram illustrating the function of an Open I/F layer.

FIG. 10 is a diagram showing an example of an API table provided in the Open I/F layer of the multifunctional apparatus.

FIG. 11 is a flow chart showing a flow of a process of registering URL registration information with use of an operation panel of the multifunctional apparatus.

FIG. 12 is a diagram showing a flow of a process that is performed in cases where the control apparatus performs scan control.

FIG. 13 is a diagram showing an example of a scan execution screen.

FIG. 14 is a diagram showing an example of operation screen data indicating the scan execution screen of FIG. 13.

FIG. 15 is a diagram showing an example of a SOAP method of a control command “Job Create”.

FIG. 16 is a diagram showing a flow of an authentication process serving as a comparative example for the present embodiment.

FIG. 17 is a diagram showing a flow of an authentication process that is performed in the present embodiment.

FIG. 18 is a diagram showing an example of a login data input screen.

FIG. 19 is a diagram showing a flow of a modified example of the authentication process.

FIG. 20 is a diagram showing a flow of control of the multifunctional apparatus with use of an automatic translation process.

FIG. 21 is a diagram showing a flow of a process that is performed in cases where the multifunctional apparatus operates in cooperation with an event tabulation application of the control apparatus.

FIG. 22 is a diagram showing an example of event transmission registration information.

FIG. 23 is a diagram showing an example of an event management table.

FIG. 24 is a diagram showing an example of job result notification.

FIG. 25 is a flow chart showing a flow of a process of displaying an operation screen.

FIG. 26 is a diagram showing an example of operation screen data.

FIG. 27 is a diagram showing UI data obtained by converting the operation screen data of FIG. 26 into a format suitable for the operation panel of the multifunctional apparatus.

FIG. 28 is a diagram showing an example of an operation screen that is based on the UI data of FIG. 27.

FIG. 29 is a diagram showing, in an embodiment of the present invention, a structure of a main part of each of the apparatuses for use in a process of causing the operation panel of the multifunctional apparatus to display a screen corresponding to a web page.

FIG. 30 is a flow chart showing, in an embodiment of the present invention, a flow of a process of causing the operation panel of the multifunctional apparatus to display a screen corresponding to a web page.

FIG. 31 is a diagram showing, in an embodiment of the present invention, an example of an online web page and an example of a display screen that is displayed by the operation panel of the multifunctional apparatus in correspondence with the web page.

FIG. 32 is a diagram showing, in an embodiment of the present invention, an example of a process by which screen data to be displayed by the operation panel of the multifunctional apparatus is divided by the control apparatus and then transmitted to the terminal apparatus.

FIG. 33 is a flow chart showing, in an embodiment of the present invention, an example of a process by which screen data to be displayed by the operation panel of the multifunctional apparatus is divided by the control apparatus and then transmitted to the terminal apparatus.

### DESCRIPTION OF THE EMBODIMENTS

An embodiment of the present invention will be described below.

(1. Apparatus Structure)

(1-1. Structure of a Multifunctional Apparatus Control System)

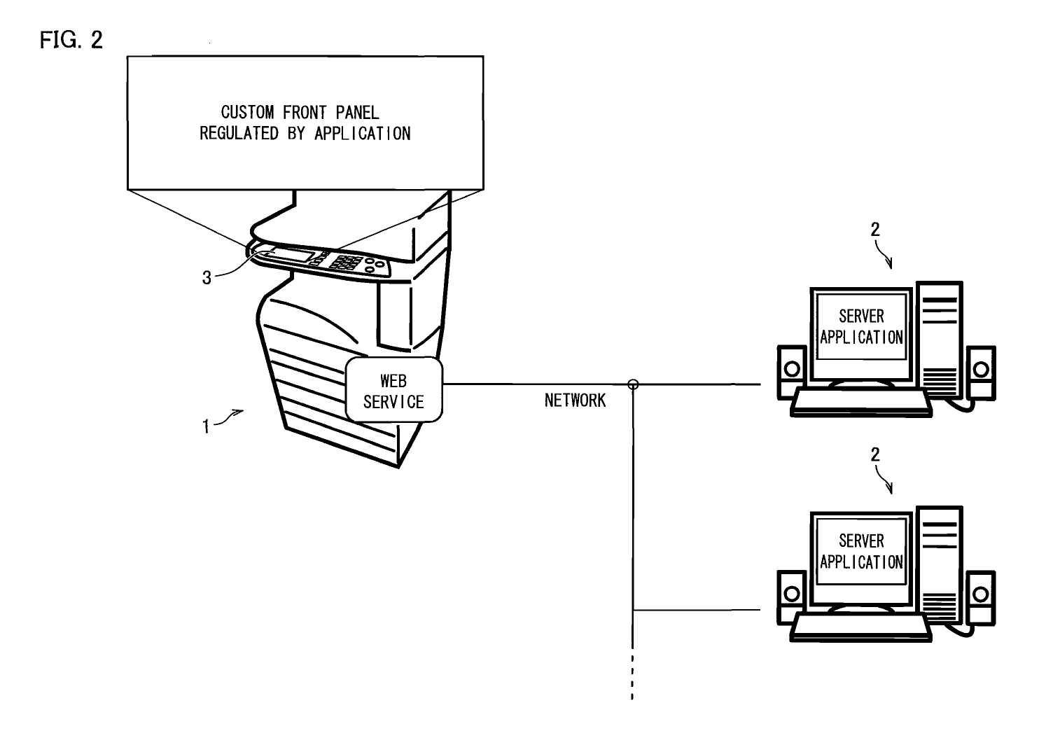

FIG. 2 is a diagram schematically showing a multifunctional apparatus control system according to the present embodiment. As shown in FIG. 2, the multifunctional apparatus control system includes a multifunctional apparatus 1, a control apparatus 2, and a communication network via which the multifunctional apparatus 1 and the control apparatus 2 are communicably connected to each other. It should be noted, as shown in FIG. 2, that the multifunctional apparatus 1 may be connected to a plurality of control apparatuses 2.

The multifunctional apparatus (terminal apparatus) 1 is an apparatus that has a plurality of image forming functions such as a copy function, a scan function, a print function, an image data transmitting function, and an image conversion function. Examples of the multifunctional apparatus 1 include an apparatus (MFP: Multi Function Printer) that is integrally constituted by a printer, a copier, a fax machine, a scanner, and an arithmetic device for transmitting, converting, and processing an image.

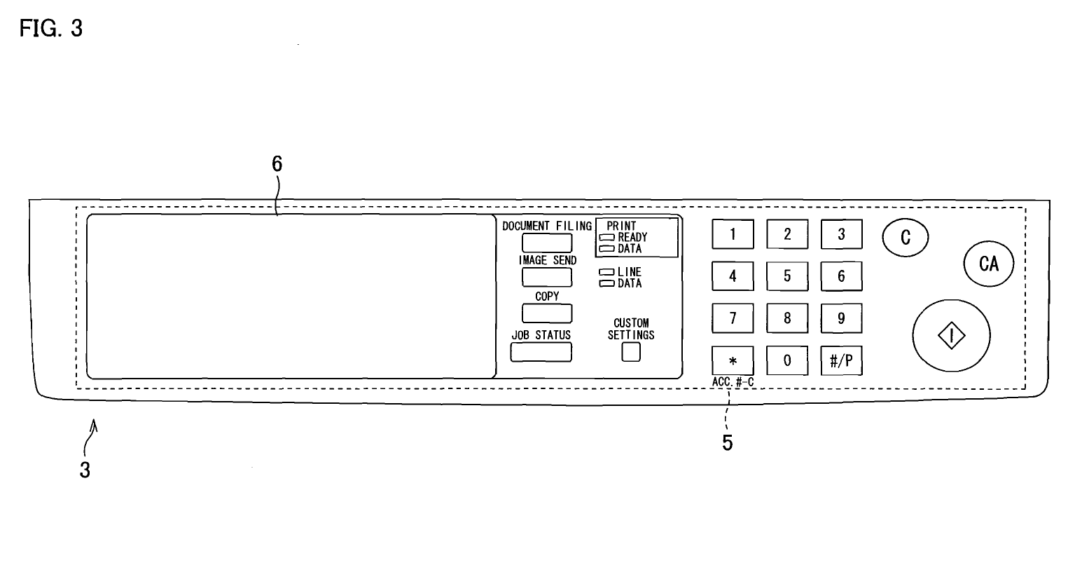

The multifunctional apparatus 1 includes an operation section 3 serving as a user interface. FIG. 3 is an enlarged view of the operation section 3. As shown in FIG. 3, the operation section 3 includes an operation panel 6 for showing an operation screen to a user and an input section 5 for accepting a user's input. The operation panel 6 employs a touch panel system, and serves also as an input section 5.

It should be noted that the multifunctional apparatus 1 may be connectable to a UI device that either replaces the operation section 3 or serves also as an operation section 3. In this case, the UI device connected to the multifunctional apparatus 1 displays an operation screen.

Examples of the control apparatus 2 include a personal computer. The control apparatus 2 has various applications installed therein. The control apparatus 2 performs processes corresponding to the applications. The control apparatus 2 can communicate with the multifunctional apparatus 1 via the communication network. It should be noted that examples of the communication network include communication lines such as the Internet, intranets, telephone lines, serial cables, other wire lines, and wireless lines.

The control apparatus 2 controls the functions of the multifunctional apparatus 1 via the communication network. In controlling the multifunctional apparatus 1, the control apparatus 2 causes the multifunctional apparatus 1 to execute a process with use of an application installed in the control apparatus 2. This enables the multifunctional apparatus 1 to be controlled by the control apparatus 2 with use of various processes that cannot be executed solely by using an information processing function of the multifunctional apparatus 1. That is, the multifunctional apparatus 1 can operate in cooperation with an application installed in the external control apparatus 2.

Further, in operating in cooperation with an application installed in the control apparatus 2, the multifunctional apparatus 1 (i) accesses the control apparatus 2, which serves as a web server, (ii) acquires operation screen data corresponding to the application, and (iii) causes the operation panel 6 to display an operation screen. That is, the application installed in the control apparatus 2 can interact with a user. This enables the multifunctional apparatus 1 to display an operation screen simply by requesting the control apparatus 2 for operation screen data. This makes it unnecessary for the multifunctional apparatus 1 to manage operation screen data.

It should be noted that the multifunctional apparatus 1 and the control apparatus 2 use HTTP or HTTPS, which uses SSL (Secure Socket Layer), to communicate with each other in requesting operation screen data or in responding to the request. The use of HTTPS makes it possible to improve security. Examples of markup languages include, but are not particularly limited to, HTML (Hypertext Markup Language), XML (Extensible Markup Language), WML (Wireless Markup Language), XHTML (Extensible Hypertext Markup Language), and other languages.

It should be noted that XML is a description language whose document structure makes it possible to transmit and receive data as simply as with HTML. XML has the advantages of: (1) enabling a user to define the meaning of a character string contained in a document; (2) not depending on any particular software; and (3) facilitating programming.

Meanwhile, in communicating a control instruction for the control apparatus 2 to control the multifunctional apparatus 1, an inter-object communication protocol using a markup language such as XML is used. Examples of such a protocol include SOAP (Simple Object Access Protocol). SOAP is a protocol, based on XML, HTTP, and the like, which is used for invoking data and services. SOAP can enable systems to cooperate with one another.

The following describes respective structures of the multifunctional apparatus 1 and the control apparatus 2.

(1-2. Structure of the Control Apparatus 2)

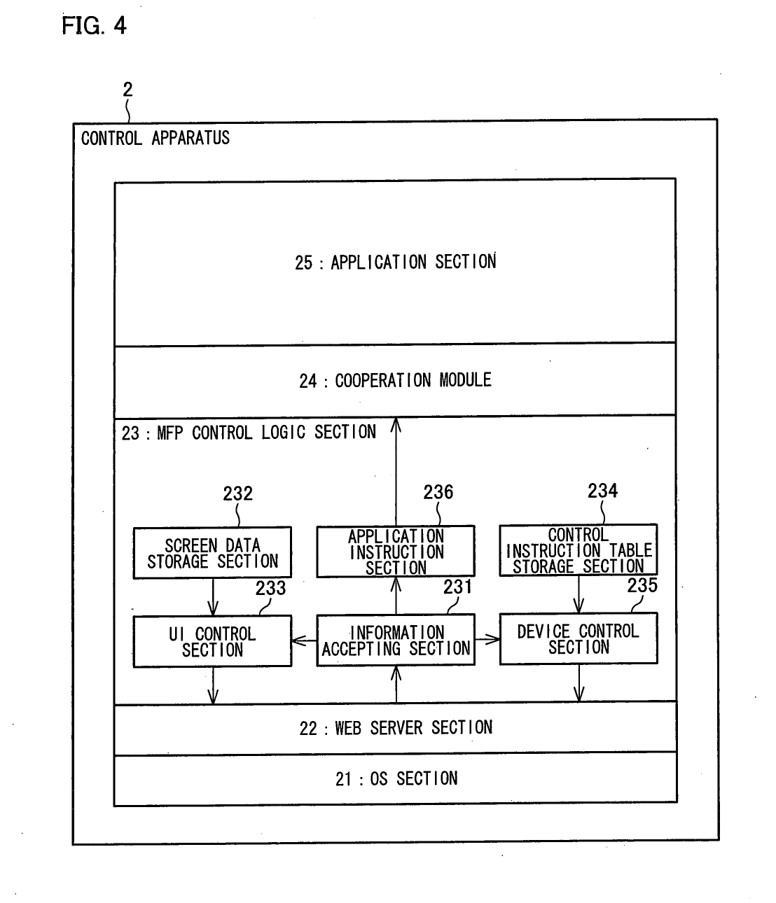

FIG. 4 is a block diagram showing an internal structure of the control apparatus 2 according to the present embodiment. As shown in FIG. 4, the control apparatus 2 includes an OS section 21, a Web server section 22, an MFP control logic section 23, a cooperation module (data acquisition means, screen data creating means, extracting means, and transmitting means) 24, and an application section 25.

The OS section 21 is a block that manages a computer system and thereby executes a process in accordance with an operating system (OS) which provides a basic user operating environment. Examples of the OS include Windows® and Linux.

The Web server section 22 performs communication with use of HTTP (Hypertext Transfer Protocol) (or HTTPS) and SOAP (Simple Object Access Protocol). The Web server section 22 receives an HTTP request from the multifunctional apparatus 1, and transmits an HTTP response corresponding to the HTTP request. Examples of the Web server section 22 include a block that performs an operation in accordance with software such as Apache.

The MFP control logic section 23 controls an operation screen (UI) of the multifunctional apparatus 1 and various functions of the apparatus. As shown in FIG. 4, the MFP control logic section 23 includes an information accepting section (request information accepting means, accepting means) 231, a screen data storage section 232, a UI control section (screen data transmitting means) 233, a control instruction table storage section 234, a device control section (control instruction transmitting means) 235, and an application instruction section 236.

The information accepting section 231 accepts information from the multifunctional apparatus 1 via the Web server section 22, and instructs the UI control section 233, the device control section 235, or the application instruction section 236 to execute a process corresponding to the information.

It should be noted that examples of the information accepted by the information accepting section 231 from the multifunctional apparatus 1 include transmission request information (request information) for requesting data designated by a URL (Uniform Resource Locator), pressed-button information indicating a button pressed on an operation screen that is based on operation screen data sent from the UI control section 233, and processing request information for the application section 25.

The information accepting section 231 acquires the processing request information from the Web server section 22 with use of SOAP. Further, the information accepting section 231 acquires the transmission request information and the pressed-button information from the Web server section 22 with use of HTTP (or HTTPS).

In cases where the information accepting section 231 accepts transmission request information, the transmission accepting section 231 outputs the transmission request information to the UI control section 233.

Further, the information accepting section 231 manages a pressed button-processing content table that correlates, with pressed button information indicating a button pressed on the operation screen, processing information indicating the content of a process that is performed by any one of the UI control section 233, the application instruction section 236, and the device control section 235 in accordance with the pressing of the button.

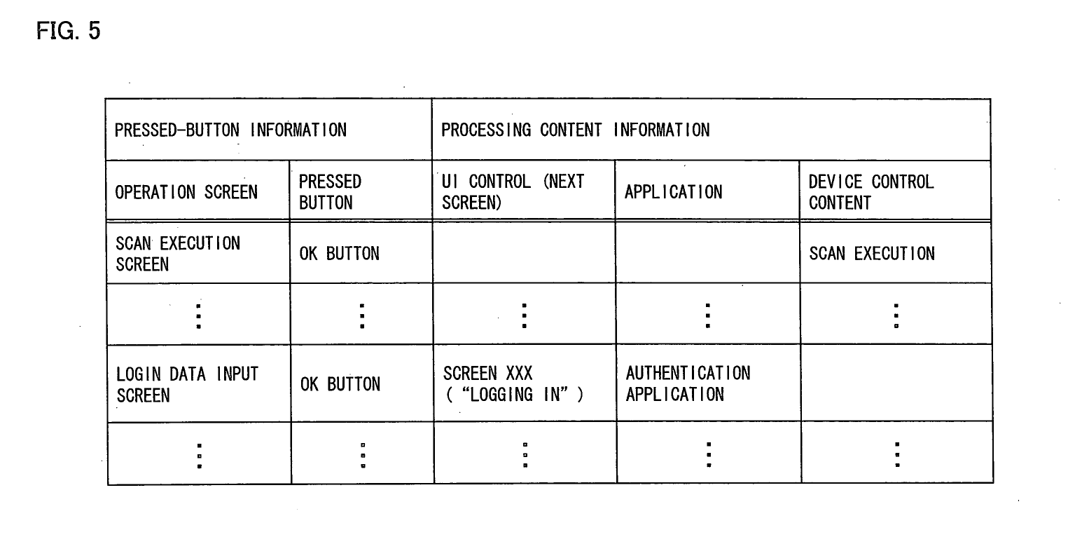

FIG. 5 is a diagram showing an example of the pressed button-processing content table. As shown in FIG. 5, the information accepting section 231 shows, for example, that pressed-button information indicating a pressing of the “OK BUTTON” of the operation screen “SCAN EXECUTION SCREEN” is correlated with processing content information indicating the exercise of device control of the control content “SCAN EXECUTION”.

Further, pressed-button information indicating a pressing of the “OK BUTTON” of the operation screen “LOGIN DATA INPUT SCREEN” is correlated with processing content information indicating that the UI control section 233 transmits data of “SCREEN XXX” (indicating “LOGGING IN”) to the multifunctional apparatus 1 as the next screen and an authentication application starts processing.

In cases where the information accepting section 231 accepts pressed-button information, the information accepting section 231 specifies, from the pressed button-processing content table, processing content information corresponding to the pressed-button information. Then, the information accepting section 231 instructs the UI control section 233, the application instruction section 236, and the device control section 235 to execute a process indicated by the specified processing content information. That is, in cases where the processing content information is information concerning UI control, the information accepting section 231 notifies the UI control section 233 of the content indicated by the information. In cases where the processing content information is information concerning an application, the information accepting section 231 notifies the application instruction section 236 of the content indicated by the information. In cases where the processing content information is information concerning device control, the information accepting section 231 notifies the device control section 235 of the content indicated by the information.

Furthermore, in addition to the pressed button-processing content table, the information accepting section 231 manages a processing request-processing content table that correlates, with processing request information for the application section 25, processing content information indicating the content of a process that is performed by any one of the UI control section 233, the application instruction section 236, and the device control section 235 in accordance with the processing request information.

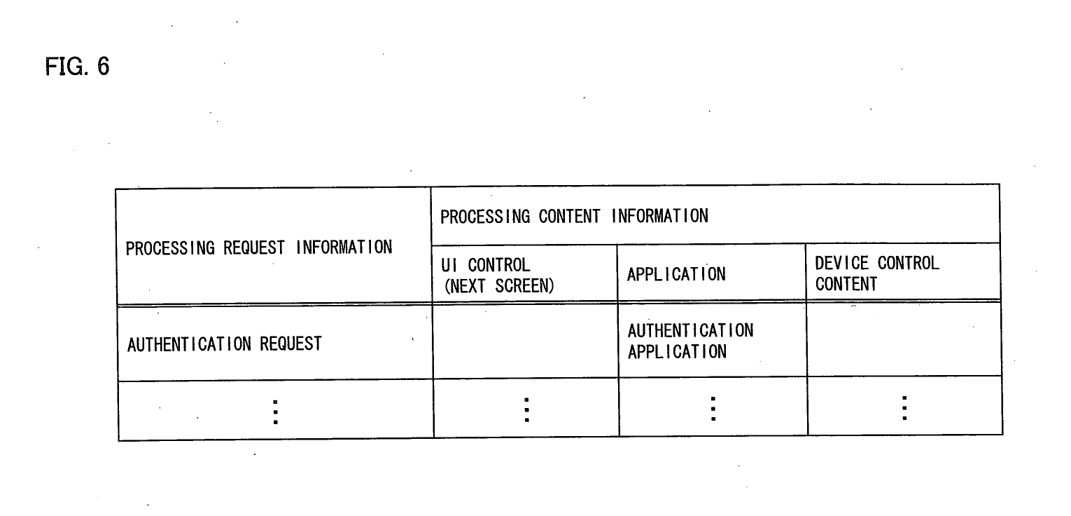

FIG. 6 is a diagram showing an example of the processing request-processing content table. In the example shown in FIG. 6, processing request information indicating an authentication request is correlated with processing content information indicating that the application instruction section 236 instructs the authentication application to start an authentication process.

In cases where the information accepting section 231 accepts processing request information, the information accepting section 231 specifies, from the processing request-processing content table, processing content information corresponding to the processing request information. Then, the information accepting section 231 instructs the UI control section 233, the application instruction section 236, and the device control section 235 to execute a process indicated by the specified processing content information.

The image data storage section 232 stores operation screen data indicating each operation screen that is displayed by the operation panel 6 of the multifunctional apparatus 1.

The UI control section 233 read out, from the image data storage section 232, operation screen data corresponding to an instruction given from the information accepting section 231, and outputs the operation screen data to the multifunctional apparatus 1 via the Web server section 22. It should be noted that the UI control section 233 transmits the operation screen data with use of HTTP (or HTTPS).

In accordance with the content of an instruction given from the information accepting section 231, the application instruction section 236 causes the application section 25 to start a predetermined process.

The control instruction table storage section 234 stores a control instruction table that correlates, with a control content for the multifunctional apparatus 1, a control instruction that is given in cases where control is performed in accordance with the control content. It should be noted, as will be mentioned later, that a control instruction stored in the control instruction table storage section 234 is an API disclosed by a Web service layer 17 of the multifunctional apparatus 1, and is a common API that does not depend on the type of multifunctional apparatus 1.

The device control section 235 reads out, from the control instruction table storage section 234, a control instruction corresponding to control content received from the information accepting section 231 or the application section 25, and transmits the control instruction to the multifunctional apparatus 1 via the Web server section 22. It should be note that the device control section 235 transmits the control instruction to the multifunctional apparatus 1 with use of SOAP.

The application section 25 is a block that performs processes corresponding to various applications. For example, the application section 25 performs operations corresponding to an authentication application for discriminating between pre-registered users and non-registered users, a document management application for saving and managing image data, an OCR (Optical Character Recognition) application, a translation application, an event tabulation application for tabulating events executed by the multifunctional apparatus 1, and other applications.

The cooperation module 24 is a module via which the application section 25 and the MFP control logic section 23 are connected to each other. The cooperation module 24 transmits a command from the application instruction section 236 to the application section 25, and transmits a command from the application section 25 to the device control section 235.

(1-3. Structure of the Multifunctional Apparatus 1)

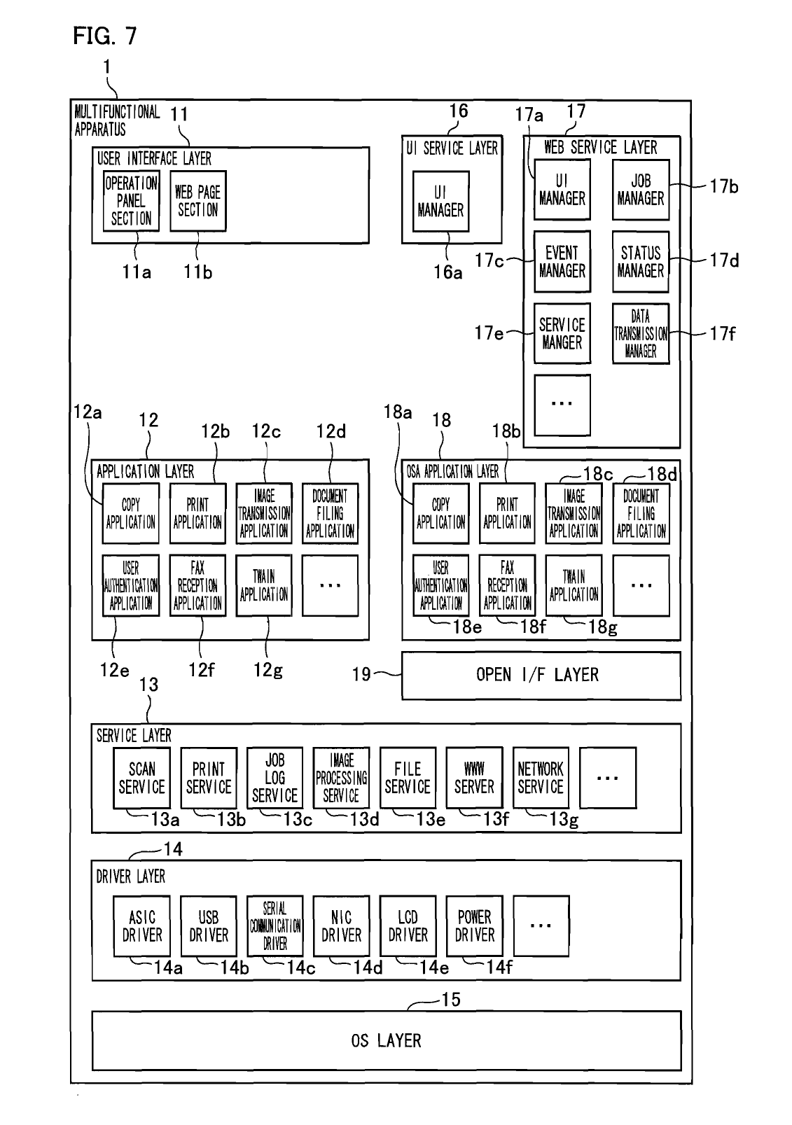

The following describes an internal structure of the multifunctional apparatus 1 with reference to a block diagram of FIG. 7. As shown in FIG. 7, the multifunctional apparatus 1 includes a user interface layer 11, an application layer 12, a service layer (elemental function executing means) 13, a driver layer 14, an OS layer 15, a UI service layer (UI processing means, operation screen identification information storage section, screen table storage section) 16, a Web service layer (control instruction accepting means) 17, an OSA application layer (apparatus function control means) 18, and an Open I/F layer (control command converting means, command storage section, registration information management section, judging means) 19.

The user interface layer 11 is an interface for a user to operate the multifunctional apparatus 1. The user interface layer 11 stores an operation screen (unique operation screen) unique to the multifunctional apparatus 1 in a unique operation screen storage section (not shown), and causes the operation panel 6 to display the unique operation screen. The user can control the multifunctional apparatus 1 by providing the unique operation screen with an input for executing a desired function.

It should be noted that the user interface layer 11 has an operation panel section 11a that performs a process of transmitting, to the application layer 12, information inputted to the operation panel 6 (operation screen) of the multifunctional apparatus 1.

Further, the user interface layer 11 has a Web page section 11b that performs a process of transmitting, to the application layer 12, information inputted to a Web page.

The application layer 12 operates in accordance with an application that controls various apparatus functions of the multifunctional apparatus 1.

The term “apparatus functions” here refers to functions that are realized by appropriately combining elemental functions such as a scan function, a print function, an image processing function, and a network function. Examples of the apparatus functions that are realized by appropriately combining the elemental functions include: a copy function, which is executed by combining the scanning function, the image processing function, and the printing function; and an image transmitting function, which is executed by combining the scanning function and the network function.

The application layer 12 of the present embodiment includes a copy application 12a for executing/controlling the copy function, a print application 12b for executing/controlling the print function, an image transmitting application 12c for executing/controlling the function (image transmitting function) of transmitting scanned image data to an external apparatus, a document filing application 12d for executing/controlling a document filing function, a user authentication application 12e for executing/controlling a user authentication function, a fax receiving application 12f for executing/controlling a fax receiving function, a TWAIN application 12g for executing/controlling a TWAIN function, and the like.

The service layer 13 is a layer located so as to be subordinate to the application layer 12, and controls various elemental functions of the multifunctional apparatus 1 in accordance with instructions given from the application layer 12.

The service layer 13 of the present embodiment includes elemental functions such as a scan service 13a for controlling a scan operation, a print service 13b, controlling a print operation, which is used at the time of executing/controlling a print function and a copy function, a job log service 13c for controlling information management for each job, an image processing service 13d for controlling image formation such as image creation, a file service 13e for performing an image managing control operation such as document filing, a WWW server service 13f for performing control for remote access via a Web page, and a network service 13g for controlling an operation of communicating with use of a LAN, a telephone line, or the like.

The driver layer 14 is located so as to be subordinate to the service layer 13, and performs an operation in accordance with software for controlling hardware of the multifunctional apparatus 1.

The driver layer 14 of the present embodiment includes an ASIC driver 14a that relates to image formation, a USB driver 14b for performing USB communication, a serial communication driver 14c for performing serial communication, a NIC driver 14d for performing LAN communication, an LCD driver 14e for performing display control of the operation panel 6, and a power driver 14f for managing power.

The OS layer 15 is a layer located so as to be subordinate to the driver layer 14, and manages an operating system.

It should be note that the user interface layer 11, the application layer 12, the service layer 13, the driver layer 14, and the OS layer 15 perform an operation in accordance with software unique to the multifunctional apparatus 1 and differ from one multifunctional apparatus 1 to another. The provision of these layers enables the multifunctional apparatus 1 to directly accept an instruction from a user without a communication network and to perform an operation in accordance with the instruction.

However, in cases where there is only a layer unique to such a multifunctional apparatus 1 as described above, a new application or the like needs to be incorporated into the multifunctional apparatus 1 for the purpose of performing control accompanied by a process using the new application. This takes a lot of trouble. In view of this, as will be described below, the multifunctional apparatus 1 of the present embodiment includes a layer which, by cooperating with an application of an external control apparatus 2, enables the multifunctional apparatus 1 to be controlled by the control apparatus 2.

The UI service layer 16 acquires operation screen data from the control apparatus 2 with use of HTTP (or HTTPS), and causes the operation panel 6 to display an operation screen that is based on the acquired operation screen data. It should be noted that the UI service layer 16 may have a function of a general-purpose Web browser.

The provision of the UI service layer 16 and the user interface layer 11 enables the user to use an operation screen of the operation panel 6 for (i) a standard operation mode in which, by operating an operation screen (displayed by the user interface layer 11) unique to the multifunctional apparatus 1, a function corresponding to the operation is executed by the multifunctional apparatus 1 or (ii) an open system mode of using a network resource (e.g., RCD application) by displaying an operation screen that is based on operation screen data acquired from the control apparatus 2.

The UI service layer 16 includes a UI manager 16a that performs display control of a UI (operation screen) provided from the control apparatus 2.

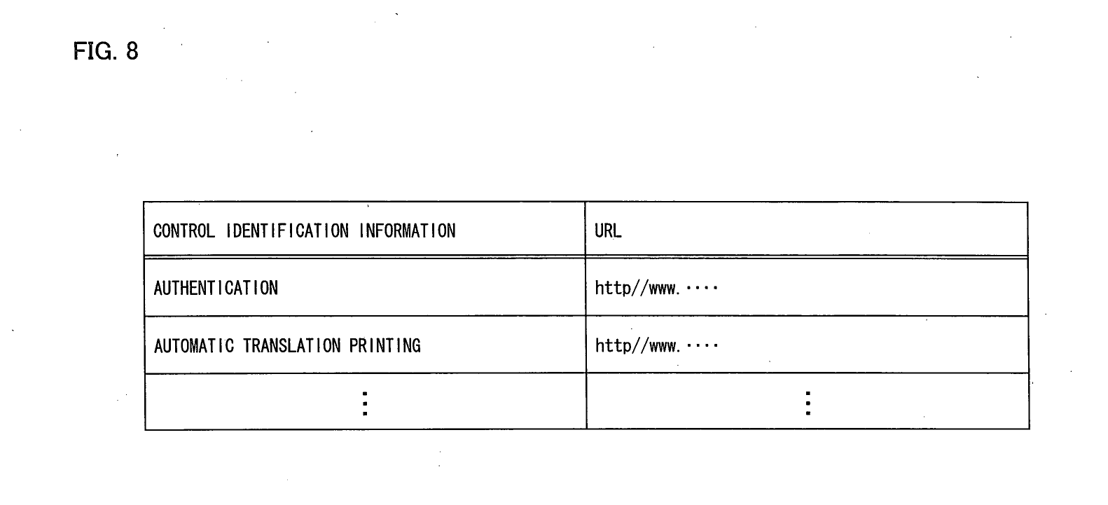

The UI service layer 16 stores URL registration information that correlates, with control identification information that identifies control accompanied by processing of the application section 25 of the control apparatus 2 (e.g., control name indicating the content of the control), a URL (operation screen identification information) of an operation screen for executing the control. That is, the UI service layer 16 includes a URL registration information storage section (operation screen identification information storage section) (not shown) in which the URL registration information is stored. FIG. 8 shows an example of the URL registration information. It should be noted that the UI service layer 16 newly registers or deletes URL registration information in accordance with a user's input to the input section 5 or in accordance with an instruction from the Web service layer 17.

Moreover, the UI manager 16a of the UI service layer 16 causes the operation panel 6 to display a list of control identification information registered in the URL registration information. Furthermore, the UI manager 16a reads out, from the URL registration information, a URL corresponding to control identification information selected by the user, and transmits, to the control apparatus 2, transmission request information for requesting operation screen data designated by the URL. In transmitting the transmission request information to the control apparatus 2, the UI manager 16a uses HTTP (or HTTPS). Then, the UI manager 16a causes the operation panel 6 to display an operation screen in accordance with the acquired operation screen data. Thereafter, the UI manager 16a transmits, to the control apparatus 2, pressed-button information indicating a button pressed on the operation screen. In transmitting the pressed-button information to the control apparatus 2, the UI manager 16a uses HTTP (or HTTPS). Then, the UI manager 16a acquires new operation screen data as a response to the transmission of the pressed-button information, and causes the operation panel 6 to display an operation screen in accordance with the new operation screen data.

The Web service layer 17 receives a control instruction from the control apparatus 2 with use of SOAP, and invokes, from the OSA application layer 18, an appropriate module corresponding to the control instruction. Further, the Web service layer 17 creates a SOAP command indicating information received from the OSA application layer 18, and transmits the SOAP command to the control apparatus 2. In the Web service layer 17, a control instruction and a module of the OSA application layer 18 which module is appropriate for control indicated by the control instruction are stored so as to be correlated with each other, and the Web service layer 17 invokes an appropriate module in accordance with the memory content.

The Web service layer 17 of the present embodiment includes a UI manager 17a for processing a Web service concerning UI control, a job manager 17b for processing a Web service concerning job control, an event manager 17c for processing a Web service concerning an event transmission request, a status manager 17d for processing a Web service concerning status control of a job or of a device, a service manager 17e for registering information concerning the OSA application layer 18, a data transmission manager 17f for processing a Web service for transmitting and receiving a job, and the like.

The OSA application layer 18 is an application for controlling the apparatus functions. The OSA application layer 18 creates a first API (first control command) for controlling an elemental function that is used for an apparatus function that is to be controlled, and then sends the first API to the Open I/F layer 19. As will be described later, a first API that is usable (disclosed) in the Open I/F layer 19 does not depend on the type of multifunctional apparatus 1. For this reason, the OSA application layer 18 does not need to change a program code for each multifunctional apparatus 1. The OSA application layer 18 outputs, to the Open I/F layer 19, a first API disclosed in the Open I/F layer 19.

The OSA application layer 18 of the present embodiment includes a copy application 18a for executing/controlling the copy function, a print application 18b for executing/controlling the print function, an image transmitting application 18c for executing/controlling the function (image transmitting function) of transmitting scanned image data to an external apparatus, a document filing application 18d for executing/controlling the document filing function, a user authentication application 18e for executing/controlling the user authentication function, a fax receiving application 18f for executing/controlling the fax receiving function, a TWAIN application 18g for executing/controlling the TWAIN function, and the like.

The Open I/F layer 19 has a function of disclosing, to the OSA application layer 18, an interface for controlling the service layer 13. The Open I/F layer 19 converts, into a second API (second control command) acceptable to the service layer 13, the first API received from the OSA application layer 18.

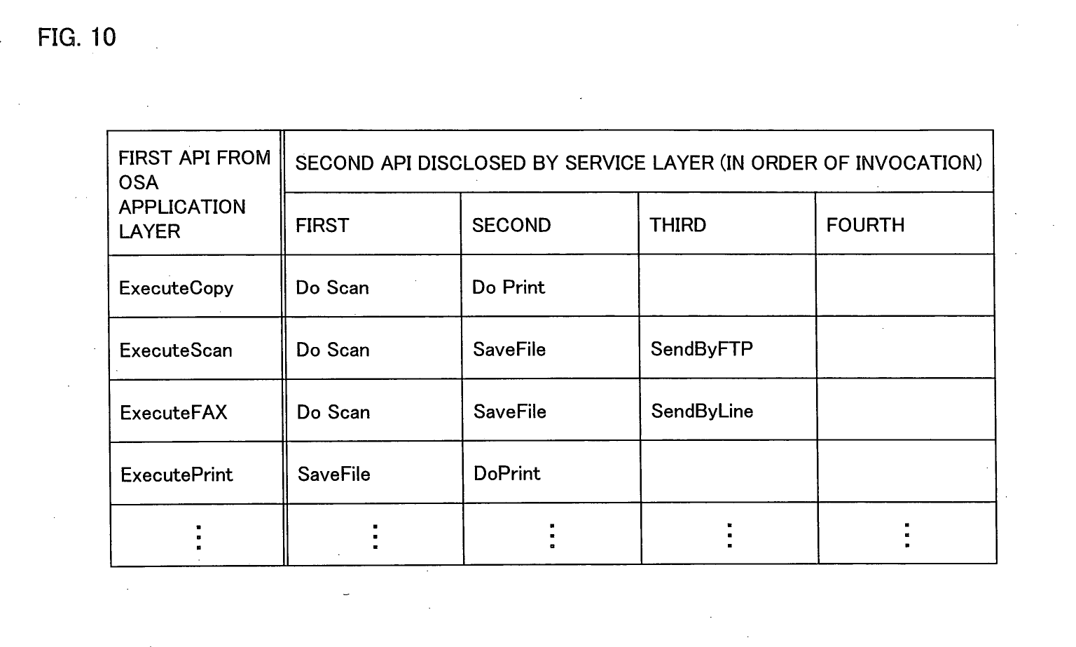

The Open I/F layer 19 includes an API table storage section (command storage section) (not shown) for storing an API table that correlates, with a first API disclosed to the OSA application layer 18 (i.e., a first control command that can be externally accepted by the Open I/F layer 19), a second API externally disclosed by the service layer 13 (i.e., a second control command acceptable to the service layer 13). The Open I/F layer 19 invokes an API of the service layer 13 in accordance with the API table. FIG. 10 is a diagram showing an example of the API table retained by the Open I/F layer 19.

The Open I/F layer 19 discloses a common API (i.e., an API acceptable to the Open I/F layer 19) to the OSA application layer 18 regardless of the type of multifunctional apparatus 1. This makes it unnecessary for the OSA application layer 18 to change a program code, and makes it possible for the Web service layer 17 to define, regardless of the type of multifunctional apparatus 1, a common method that is disclosed to an external apparatus. That is, each control apparatus 2 can make a request to the Web service layer 17 with use of a common method regardless of the type of multifunctional apparatus 1.

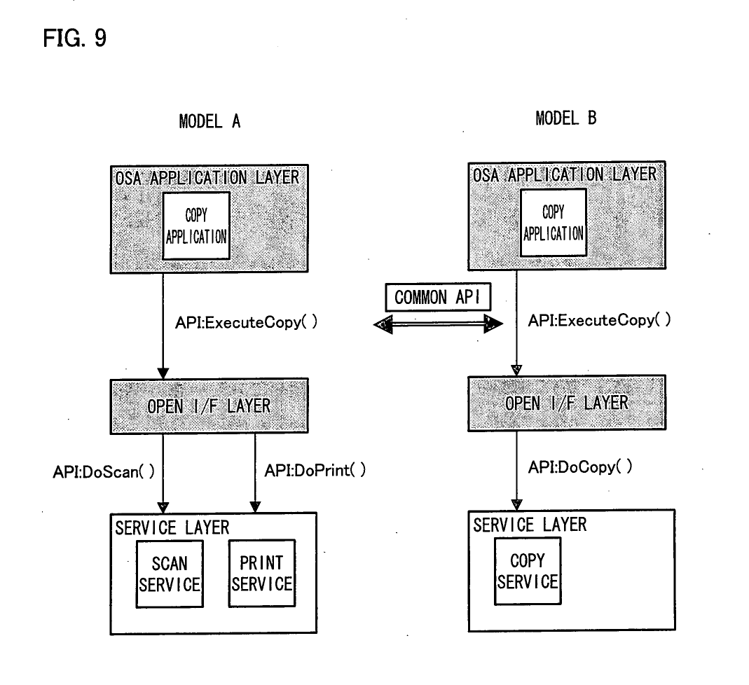

FIG. 9 is a diagram illustrating the function of an Open I/F layer 19. In FIG. 9, Model A of multifunctional apparatus 1 has a service layer 13 that includes a scan service 13a and a print service 13b as elemental functions. In this case, Model A of multifunctional apparatus 1 has an Open I/F layer 19 that stores an API table in which, as shown in FIG. 10, a first API “ExecuteCopy” is correlated with second APIs “DoScan” and “DoPrint”. Therefore, even when the Open I/F layer 19 accepts the first API “ExecuteCopy”, the Open I/F layer 19 can cause the scan service 13a and the print service 13b to be executed.

Meanwhile, Model B of multifunctional apparatus 1 has a service layer 13 that includes a copy service as an elemental function. In this case, Model B of multifunctional apparatus 1 has an Open I/F layer 19 that stores an API table in which the first API “ExecuteCopy” is correlated with a second API “DoCopy”. Therefore, even when the Open I/F layer 19 accepts the first API “ExecuteCopy”, the Open I/F layer 19 can cause the copy service to be executed.

Thus, the Open I/F layer 19 has a function of converting an API in accordance with an API table. Therefore, the Open I/F layer 19 can disclose a common first API regardless of the type of multifunctional apparatus 1. This makes it possible to use a common API in a layer superior to the Open I/F layer 19. That is, an external control apparatus 2 only needs to output a common control instruction to the multifunctional apparatus 1 regardless of the type of multifunctional apparatus 1.

(2. Process of Registering URL Registration Information)

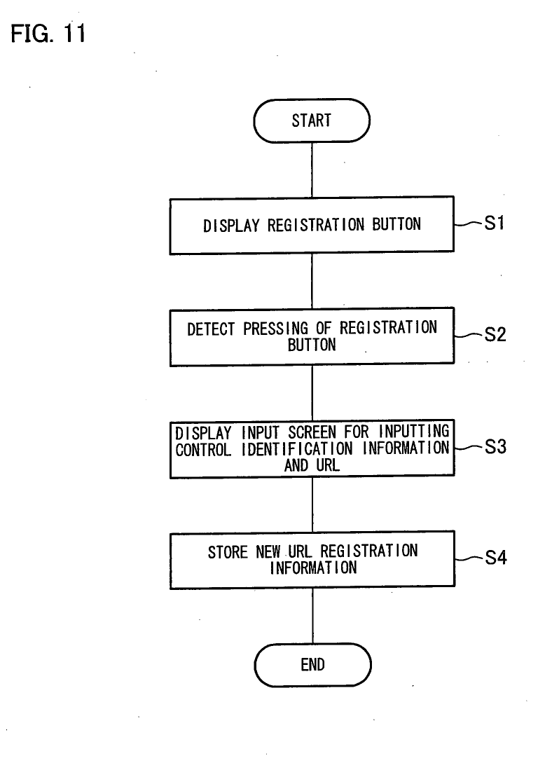

The following describes a process of registering URL registration information in the UI service layer 16. FIG. 11 is a flow chart showing a flow of a process of performing a registration process with use of the operation panel 6. The following describes a case where the registration process is performed with use the operation panel 6 of the multifunctional apparatus 1. However, the registration process is not limited to this. For example, the registration process may be performed in response to a request sent from an external apparatus such as a personal computer.

The UI manager 16a of the UI service layer 16 causes the operation panel 6 to display a registration button for registering new URL registration information (S1). Next, the UI manager 16a detects a pressing of the registration button (S2).

Thereafter, the UI manager 16a causes the operation panel 6 to display instructions to input (i) control identification information that identifies control accompanied by processing of the application section 25 of the control apparatus 2 (e.g., a name that directly indicates the content of the control) and (ii) a URL of an operation screen for executing the control (S3).

Then, the UI manager 16a creates new URL registration information by which control identification information inputted to the input section 5 is correlated with a URL, and then stores the URL registration information in the UI service layer 16 (S4). This is the end of the registration process.

It should be noted that the UI manager 16a may cause the operation panel 6 to display an edit button or a delete button. Moreover, when the edit button is pressed, the UI manager 16a edits registered URL registration information in accordance with a user's input to the input section 5. Alternatively, when the delete button is pressed, the UI manager 16a deletes registered URL registration information in accordance with a user's input to the input section 5.

(3. Process that is Performed in Cases where the Multifunctional Apparatus 1 Operates in Cooperation with an External Application)

(3-1. Concrete Example 1: Document Management Application)

The following describes Concrete Example 1 of the process that is performed in cases where the multifunctional apparatus 1 has URL registration information registered therein as described above and operates in cooperation with an external application in accordance with the URL registration information.

The present concrete example shows a process that is performed in cases where image data scanned by the multifunctional apparatus 1 is stored in a document management application of the control apparatus 2. In this case, the UI service layer 16 of the multifunctional apparatus 1 stores URL registration information that correlates, with control identification information “document management”, a URL of operation screen data indicating an operation screen for cooperating with the document management application.

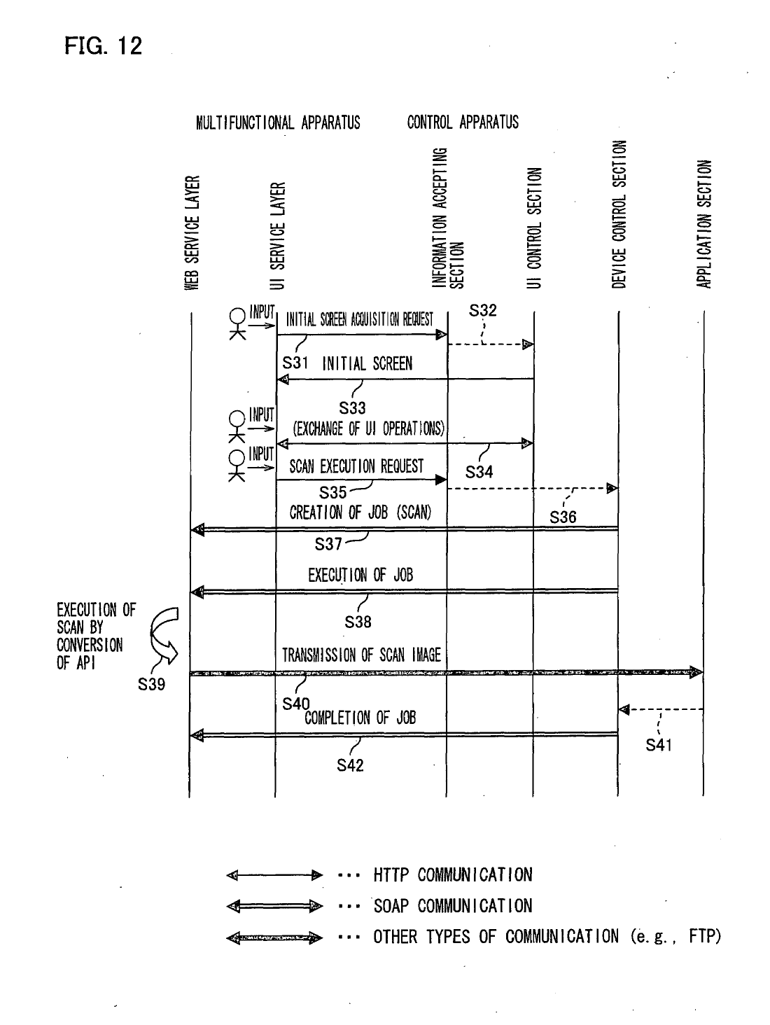

FIG. 12 is a diagram showing a flow of the process that is performed in the present concrete example.

First, the UI manager 16a of the UI service layer 16 causes the operation panel 6 to display a list of URL registration information stored in the UI service layer 16. It is assumed here that the user has selected control identification information “document management”. Then, the UI manager 16a specifies, from the URL registration information, a URL corresponding to the control identification information “document management”. Thereafter, the UI manager 16a outputs, to the control apparatus 2, transmission request information for requesting transmission of data designated by the URL (the data being herein referred to as initial operation screen data for performing control indicated by the control identification information “document management”) (S31). In making the request, the UI manager 16a uses HTTP (or HTTPS).

The information accepting section 231 of the control apparatus 2 receives the transmission request information, and sends it to the UI control section 233 (S32).

The UI control section 233 reads out, from the screen data storage section 232, operation screen data corresponding to a URL designated by the transmission request information. In so doing, the UI control section 233 reads out operation screen data indicating an input screen for inputting login information for logging in the document management application. Then, the UI control section 233 sends the read operation screen data to the multifunctional apparatus 1 as a response to the transmission request information with use of HTTP (S33).

In the multifunctional apparatus 1, the UI manager 16a of the UI service layer 16 receives the operation screen data, and then causes the operation panel 6 to display an operation screen that is based on the operation screen data (an input screen for inputting login information for logging in the document management application). It should be noted that the process performed in the UI manager 16a so that the operation screen is displayed will be described later in detail.

Thereafter, the UI manager 16a of the multifunctional apparatus 1 and the information accepting section 231 and UI control section 233 of the control apparatus 2 perform a process of making a transition from the operation screen to another operation screen (S34).

Specifically, when an OK button is pressed on the input screen for inputting the login information, the UI manager 16a transmits, to the control apparatus 2, the input login information and pressed-button information indicating that the OK button has been pressed. In so doing, the UI manager 16a uses HTTP. Upon receiving the pressed-button information, the information accepting section 231 refers to the pressed button-processing content table and instructs the application instruction section 236 to cause the document management application to start a login authentication process. Then, when the document management application confirms successful authentication, the document management application causes the UI control section 233 to output operation screen data indicating a selection screen for selecting a destination in which to save the image data. The UI control section 233 transmits the operation screen data to the multifunctional apparatus 1 as a response to the transmission of the pressed-button information.

In this way, the UI manager 16a of the multifunctional apparatus 1 and the information accepting section 231 and UI control section 233 of the control apparatus 2 make a transition from the operation screen to the selection screen for selecting the destination in which to save the image data, a setting screen for setting scan execution parameters, an input screen for inputting metadata, and a scan execution screen.

When a scan execution button is pressed on the scan execution screen, which is the last operation screen, the UI manager 16a transmits, to the control apparatus 2, pressed-button information indicating that the scan execution button has been pressed (S35). In so doing, the UI manager 16a uses HTTP.

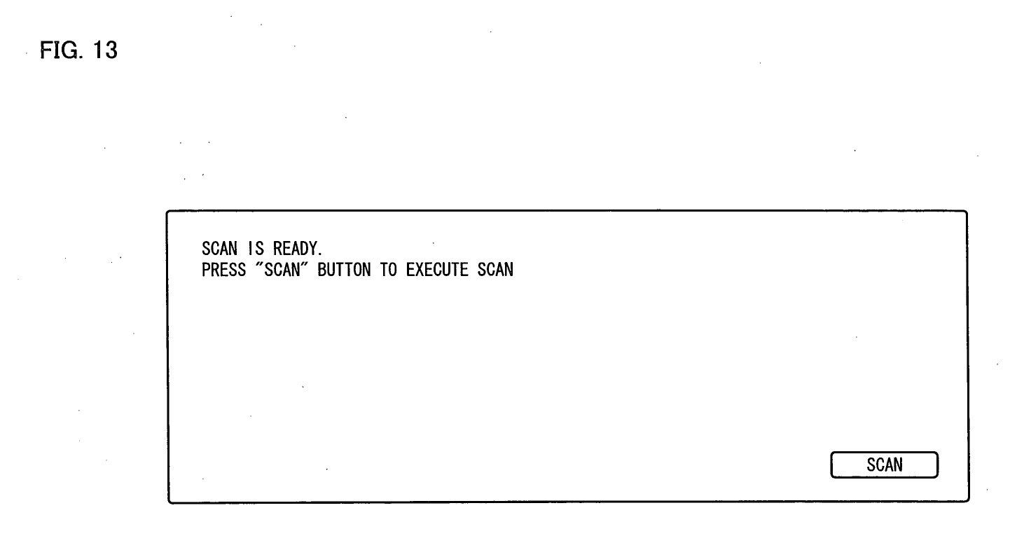

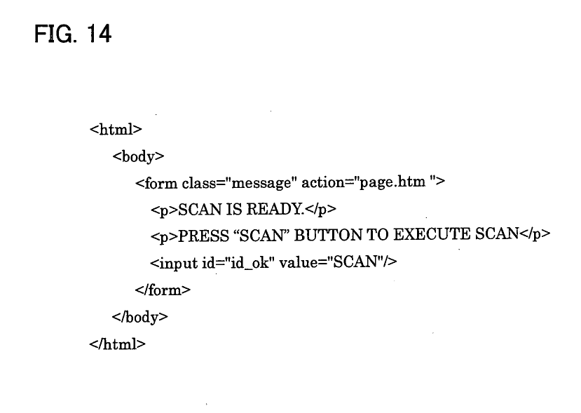

FIG. 13 is a diagram showing an example of the scan execution screen. Further, FIG. 14 is a diagram showing an example of operation screen data indicating the scan execution screen of FIG. 13.

In this case, the UI manager 16a transmits pressed-button information indicating that a scan execution button (id=“id_ok”) has been pressed.

In response to the pressing of the scan execution button (id=“id_ok”), the information accepting section 231 of the control apparatus 2 refers to the pressed button-processing content table (see FIG. 5) and instructs the device control section 235 to create a control instruction corresponding to a control content “scan” (S36).

The device control section 235 reads out, from the control instruction table storage section 234, the control instruction corresponding to the control content “scan”, and transmits the control instruction to the multifunctional apparatus 1 with use of SOAP. For example, in cases where the control instruction table contains control instructions “JobCreate”, “ExecuteScan”, and “JobClose” arranged in this order so as to correspond to the control content “scan”, the device control section 235 sequentially outputs the control instructions “JobCreate” and “ExecuteScan” (S37, S38). The control instruction “ExecuteScan” contains various parameters set by the UI.

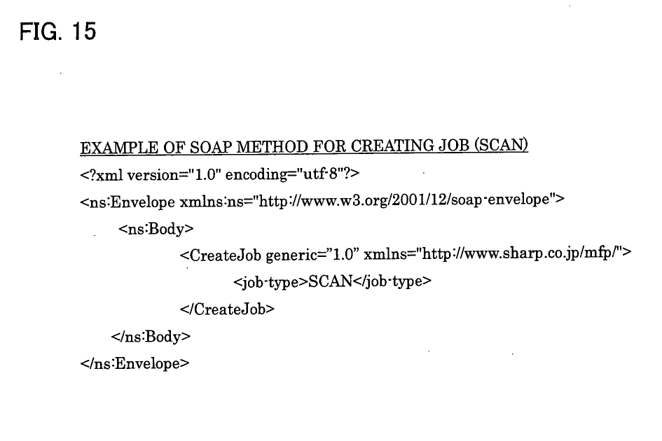

It should be noted that the device control section 235 transmits the control instructions with use of SOAP. FIG. 15 is a diagram showing an example of a SOAP method for creating a job (scan).

Meanwhile, in the multifunctional apparatus 1, which has received the control instructions with use of SOAP, the job manager 17b of the Web service layer 17 invokes an appropriate module of the OSA application layer 18 in accordance with the control instruction “ExecuteScan”. Then, a scan is executed as described below (S39).

That is, the job manager 17b stores a table that correlates a control instruction with a module of the OSA application layer 18 which module is used for executing an apparatus function for performing control indicated by the control instruction. In this case, the job manager 17b stores a table that correlates the control instruction “ExecuteScan” with the image transmitting application 18c of the OSA application layer 18. Therefore, the job manager 17b causes the image transmitting application 18c of the OSA application layer 18 to be executed. In so doing, the job manager 17b outputs, to the image transmitting application 18c, various parameters added to the control instruction.

Thereafter, the image transmitting application 18c outputs, to the subordinate Open I/F layer 19, a first API (“ExecuteScan” in this case) externally disclosed by the Open I/F layer 19.

The Open I/F layer 19 reads out, from the API table (see FIG. 10), second APIs (“DoScan”, “SaveFile”, and “SendByFTP” in this case), corresponding to the first API (“ExecuteScan” in this case) received from the OSA application layer 18 (image transmitting application 18c in this case), which can be accepted by the service layer 13. Then, the Open I/F layer 19 outputs the read second APIs to the service layer 13 in the order of invocation as stored in the API table. In response to the second APIs, the service layer 13 causes elemental functions (scan service, file service, and network service in this case) to be executed. In so doing, the service layer 13 causes an appropriate module of the driver layer 14 to be executed.

Then, the service layer 13 scans an image (S39), and then sends the scanned image data to the control apparatus 2 with use of FTP (S40).

Specifically, first, the Open I/F layer 19 sends the second APIs “DoScan” and “SaveFile” to the service layer 13. The service layer 13 stores the scanned image data in a hard disk drive or memory provided in the multifunctional apparatus 1, and then notifies the image transmitting application 18c of a storage area where the image data is stored. Then, the image transmitting application 18c notifies the Open I/F layer 19 of the storage area. Then, the Open I/F layer 19 sends, to the service layer 13, a second API “SendByFTP” indicating that the image data stored in the notified storage area will be transmitted by FTP. With this, the file service 13e and network service 13g of the service layer 13 read out the image data from the indicated storage area, and then transmit the image data to an indicated destination with use of FTP.

In the control apparatus 2, the cooperation module 24 and the document management application of the application section 25 wait for the image data. Then, the cooperation module 24 sends the received image data to the document management application. Furthermore, the document management application performs a process of saving the image data in a folder set as the save destination by the UI.

When the document management application completes the process, the application section 25 notifies the device control section 235 that the process has been completed (S41). In response to this notification, the device control section 235 transmits the last control instruction “JobClose” to the multifunctional apparatus 1 (S42). This is the end of the process.

As described above, the multifunctional apparatus 1 designates the pre-registered URL, thereby being able to acquire the operation screen data for use of the document management application of the control apparatus 2 and to cause the operation panel 6 to display the operation screen. Based on the information inputted to the operation screen, the MFP control logic section 23 and application section 25 of the control apparatus 2 control the operation screen being displayed by the operation panel 6 of the multifunctional apparatus 1, and control the elemental functions of the multifunctional apparatus 1.

In addition to the control instructions “JobCreate”, “ExecuteScan”, and “JobClose”, the device control section 235 may output, in response to a user's input to the operation screen, a control instruction to set job parameters and a control instruction to stop or cancel a job.

(3-2. Concrete Example 2: Authentication Application)

The following describes Concrete Example 2 of the process that is performed in cases where the multifunctional apparatus 1 has URL registration information registered therein and operates in cooperation with an external application in accordance with the URL registration information.

The preset concrete example is an example where the multifunctional apparatus 1 operates in cooperation with an authentication application of the control apparatus 2. That is, the control apparatus 2 performs an authentication process of determining whether or not a user of the multifunctional apparatus 1 is an authorized user, and restricts the apparatus functions of the multifunctional apparatus 1 in accordance with a result of the authentication.

A comparative example of the present concrete example will be described below prior to the description of the present concrete example.

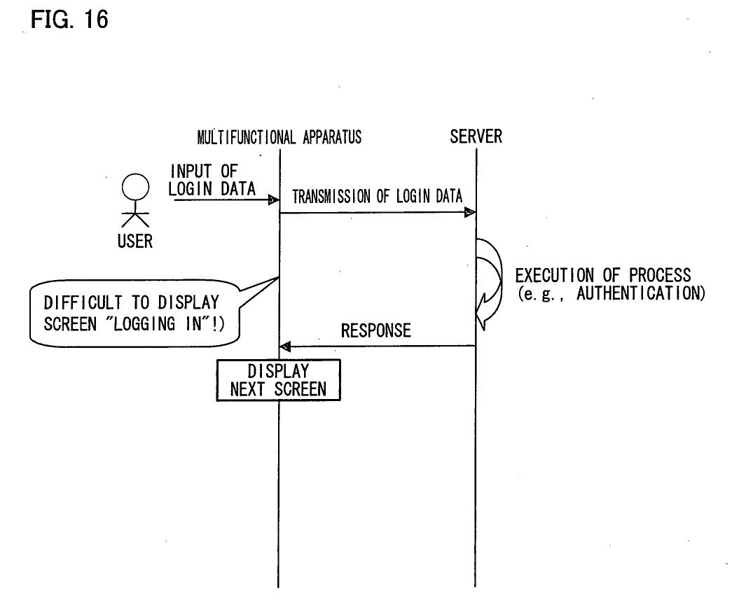

FIG. 16 is a diagram showing a flow of an authentication process that is performed in the comparative example where communication is performed with use of HTTP alone. According to HTTP, an HTTP request and an HTTP response are communicated as a pair. That is, a client sends an HTTP request to a server and in return the server sends, to the client, an HTTP response corresponding to the HTTP request. The server cannot send any data to the client unless the server receives an HTTP request from the client. Further, the client cannot receive any data from the server unless the client sends an HTTP request to the server.

As shown in FIG. 16, in the comparative example, the server sends the next operation screen data to the multifunctional apparatus 1 after the end of the authentication process in response to login data transmitted from the multifunctional apparatus 1 (client). In this case, the user cannot view the next screen until the end of the authentication process. This causes the user to worry whether the authentication process is being performed properly. Therefore, it is necessary that the operation panel of the multifunctional apparatus 1 display a screen “LOGGING IN”. However, in the comparative example, when the screen “LOGGING IN” is sent in reply to the transmitted login data, the next operation screen data becomes unable to be sent. This is because there is no request from the multifunctional apparatus 1.

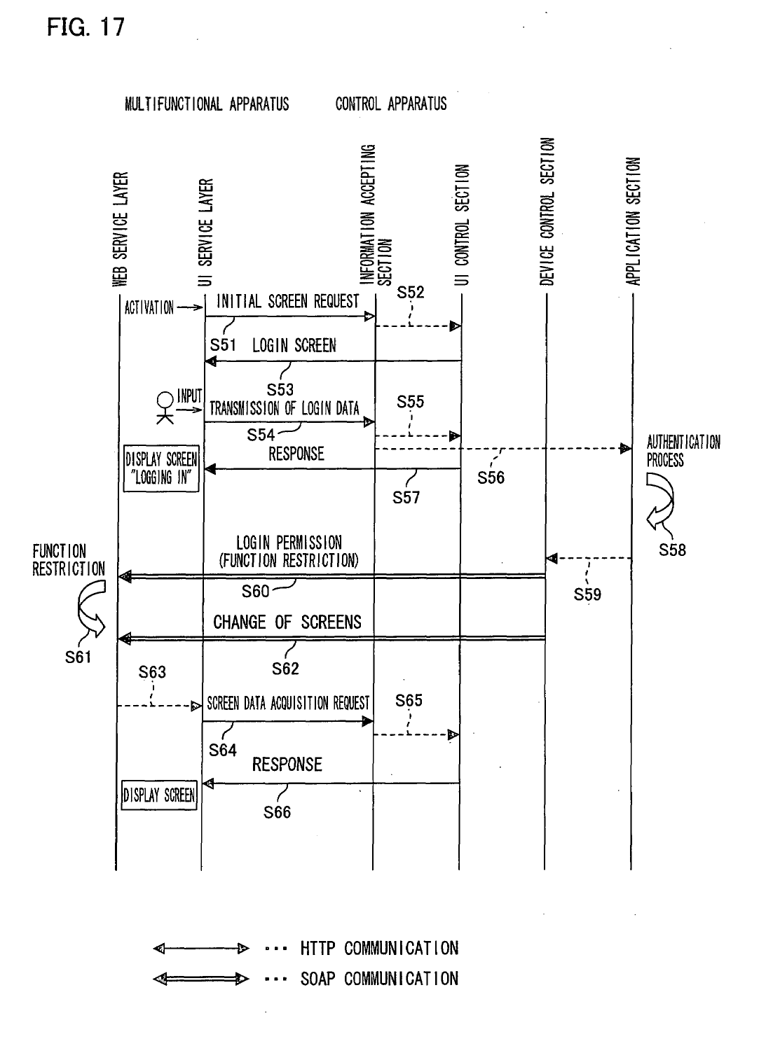

According to the present concrete example, even in cases where the application section 25 of the control apparatus 2 performs some sort of process in response to an HTTP request sent from the multifunctional apparatus 1, it is possible to make a transition from one operation screen to another on the operation panel 6 of the multifunctional apparatus 1 during the process. The present concrete example is an example suitable for explaining this effect. FIG. 17 is a diagram showing a flow of an authentication process that is performed in the present concrete example.

In the multifunctional apparatus 1, first, in activating display processing for the operation panel 6, the UI manager 16a of the UI service layer 16 specifies, from the URL registration information registered in the UI service layer 16, a URL corresponding to control identification information “authentication control”, and then outputs, to the control apparatus 2, transmission request information for requesting transmission of data indicating an operation screen designated by the URL (S51).

Then, in the control apparatus 2, the information accepting section 231 sends the transmission request information to the UI control section 233 (S52) and in return the UI control section 233 sends, to the multifunctional apparatus 1, operation screen data indicating an operation screen (login data input screen in this case) designated by the transmission request information (S53).

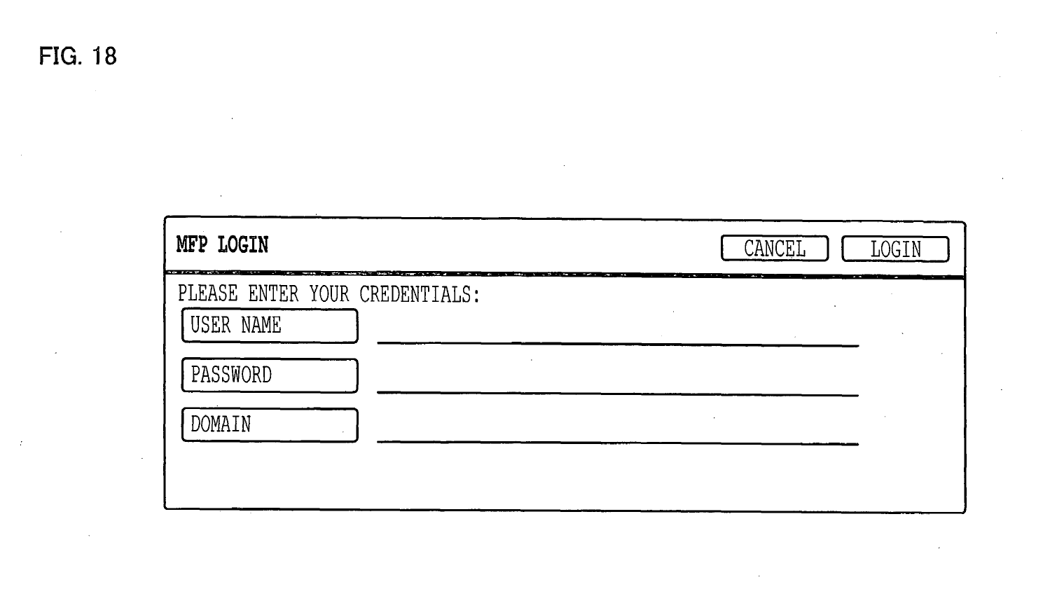

Then, in the multifunctional apparatus 1, the UI manager 16a of the UI service layer 16 displays the login data input screen in accordance with the received operation screen data. FIG. 18 is a diagram showing an example of the login data input screen.

The user inputs login data and press the OK button. In response to this input, the UI manager 16a transmits, to the control apparatus 2, the input login data and pressed-button information indicating that the OK button has been pressed (S54).

Upon receiving the pressed-button information, the information accepting section 231 refers to the pressed button-processing content table (see FIG. 5) and instructs the UI control section 233 to transmit an operation screen indicating “LOGGING IN” (S55). The information accepting section 231 also instructs the application instruction section 236 to start processing the authentication application (S56).

In accordance with the transmission instruction given in S55, the UI control section 233 reads out, from the screen data storage section 232, data corresponding to the operation screen indicating “LOGGING IN” (S57), and transmits the data to the multifunctional apparatus 1.

Meanwhile, the application instruction section 236 activates the authentication application in accordance with the instruction given in S56. Then, the authentication application performs an authentication process by using a pre-registered authentication database (S58).

When the authentication application succeeds in the authentication process, the authentication application outputs, to the device control section 235, (i) control content “restriction of elemental functions”, corresponding to the login user, which indicates restriction of use of the elemental functions of the multifunctional apparatus 1 and (ii) control content “screen change”, corresponding to the login user, which indicates a shift to a predetermined screen (S59).

The authentication application stores, for each login user, information for restricting use of elemental functions. For example, in cases where an administrator would like to prohibit a user A from performing color printing, the administrator registers the user A and the prohibition of color printing in advance in the authentication application so that the user A is correlated with the prohibition of color printing.

Then, the device control section 235 acquires, from the control instruction table storage section 234, a control instruction (“restriction of elemental functions”) corresponding to the control content “restriction of elemental functions”, and outputs the control instruction (“restriction of elemental functions”) to the multifunctional apparatus 1 (S60).

In the multifunctional apparatus 1, which has received the control instruction (“restriction of elemental functions”), the service manager 17e of the Web service layer 17 invokes the user authentication application 18e of the OSA application layer 18. Then, in accordance with the control instruction, the user authentication application 18e sends, to the Open I/F layer 19, a first API for controlling the restriction of the elemental functions of the service layer 13. The Open I/F layer 19 converts, into a second API acceptable to the service layer 13, the first API sent from the user authentication application 18e, and then provides the service layer 13 with the instruction.

With this, the elemental functions are restricted, for example, so that the print service 13b of the service layer 13 is prohibited from performing color printing and the maximum number of print copies is limited to 5 (S61).

Further, the device control section 235 acquires, from the control instruction table storage section 234, a control instruction (“SCREEN CHANGE”) corresponding to the control content “screen change”, and then outputs the control instruction (“screen change”) to the multifunctional apparatus 1 (S62). It should be noted that the control instruction (“screen change”) contains a URL corresponding to the next operation screen.

In the multifunctional apparatus, which has received the control instruction (“screen change”), the UI manager 17a of the Web service layer 17 instructs the UI service layer 16 to display an operation screen designated by the URL added to the control instruction (S63).

Then, the UI manager 16a of the UI service layer 16 outputs, to the control apparatus 2, transmission request information by which transmission of operation screen data specified by the designated URL is requested (S64). In so doing, the UI manager 16a uses HTTP. In the control apparatus 2, the information accepting section 231 sends the transmission request information to the UI control section 233 (S65). The UI control section 233 transmits, to the multifunctional apparatus 1, operation screen data corresponding to a URL designated by the transmission request information (S66), and the multifunctional apparatus 1 causes the operation panel 6 to display an operation screen.

(3-3. Modified Example of Concrete Example 2)

The following describes a modified example of Concrete Example 2. In Concrete Example 2, the multifunctional apparatus 1 is such that the UI service layer 16 acquires, from the control apparatus 2, data corresponding to the login data input screen, causes the operation panel 6 to display the login data input screen, and acquires login data from the input section 5. However, the login data may be acquired from an external personal computer 4 instead of the input section 5. The present modified example is an example where the login data is acquired from the external personal computer 4. In the present modified example, the external personal computer 4 is defined as a print job creating apparatus that outputs a print job to the multifunctional apparatus 1 and thereby causes the multifunctional apparatus 1 to form an image corresponding to the print job.

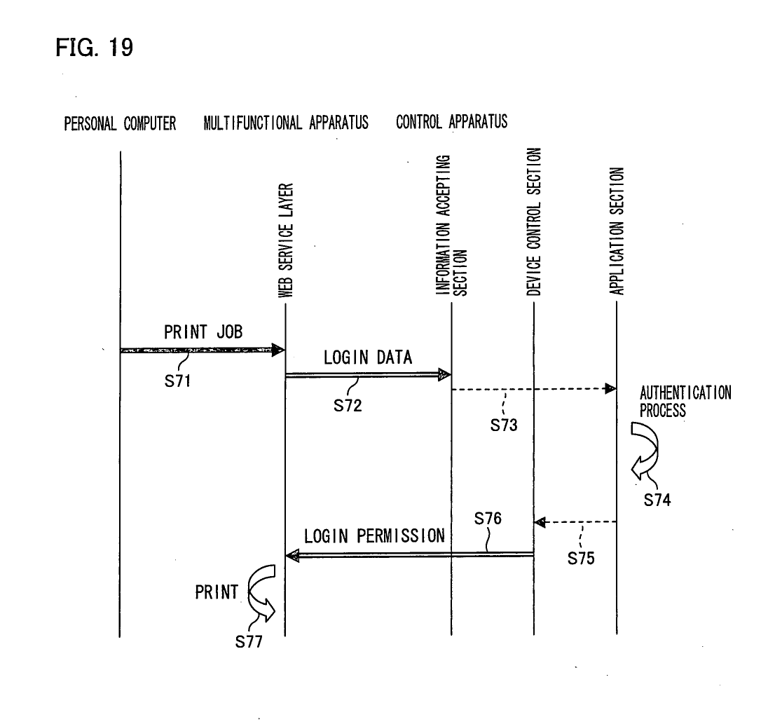

FIG. 19 is a diagram showing a flow of a process that is performed in the present modified example.

First, the personal computer 4 creates a print job, and then outputs the print job to the multifunctional apparatus 1 (S71). In so doing, the personal computer 4 also outputs login data containing a user name and a password.

The service manager 17e of the Web service layer 17 of the multifunctional apparatus 1 extracts the login data from the print job. Then, the service manager 17e transmits, to the control terminal 2, authentication processing request information to which the extracted login data has been added (S72). In so doing, the service manager 17e uses SOAP.

In the control apparatus 2, the information accepting section 231, which has received the authentication processing request information, refers to the processing request-processing content table (see FIG. 6) and provides the application instruction section 236 with an activation instruction to activate the authentication application (S73). Then, the application instruction section 236 activates the authentication application. The authentication application performs an authentication process by using a pre-registered authentication database (S74).

When the authentication application succeeds in the authentication process, the authentication application outputs, to the device control section 235, a control content “permission of a printing process” indicating that a printing process is permitted (S75).

Then, the device control section 235 acquires, from the control instruction table 234, a control instruction corresponding to the control content “permission of a printing process”, and outputs the control instruction to the multifunctional apparatus 1 (S76).

In the multifunctional apparatus 1, which has received the control instruction, the service manager 17e of the Web service layer 17 invokes the user authentication application 18e of the OSA application layer 18. Then, the user authentication application 18e sends, to the Open I/F layer 19, a first API indicating that the print function is turned ON. The Open I/F layer 19 converts, into a second API that acceptable to the service layer 13, the first API sent from the user authentication application 18e, and then provides the service layer 13 with the instruction. With this, the print service 13b of the service layer 13 is turned ON, so that a print process that is based on the print job transmitted from the personal computer 4 is performed (S77).

(3-4. Concrete Example: Control Using an Automatic Translation Process)

The following describes Concrete Example 3 of the process that is performed in cases where the multifunctional apparatus 1 has URL registration information registered therein and operates in cooperation with an external application in accordance with the URL registration information.

According to the present embodiment, it is possible to perform a background process in the control apparatus 2 while making a transition from one operation screen to another in the multifunctional apparatus 1. This brings an effect of improving the speed of processing in the control apparatus 2. The present concrete example is suitable for explaining the effect.

In Concrete Example 3, the multifunctional apparatus 1 cooperates with an OCR application and a translation application of the application section 25 of the control apparatus 2. That is, the OCR application extracts text data from image data scanned by the multifunctional apparatus 1, and the translation application translates the text data into another language. Then, the translated document is printed by the multifunctional apparatus 1.

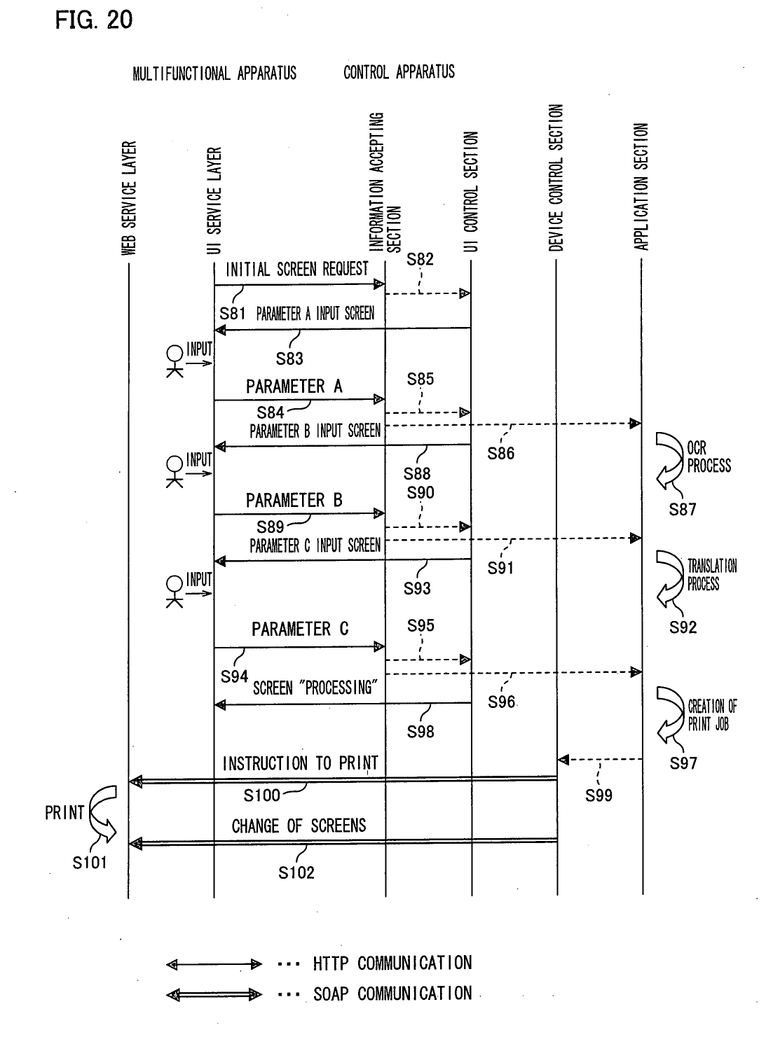

In Concrete Example 3, the control apparatus 2 acquires the scanned image data from the multifunctional apparatus 1 in accordance with such a process as shown in FIG. 12. The subsequent process will be described below with reference to FIG. 20.

First, in the multifunctional apparatus 1, the UI manager 16a of the UI service layer 16 causes the operation panel 6 to display a list of URL registration information stored in a URL registration information storage section (not shown) of the UI service layer 16. The list contains a URL of an operation screen corresponding to control using an automatic translation process. It is assumed here that the user selects the URL. With this, the UI manager 16a transmits, to the control apparatus 2, transmission request information for requesting transmission of data corresponding to the selected URL (S81).

In the control apparatus 2, the information accepting section 231, which has accepted the transmission request information, sends the transmission request information to the UI control section 233 (S82). The UI control section 233 reads out, from the screen data storage section 232, operation screen data (data indicating a parameter A input screen for use in an OCR process, in this case) corresponding to the URL indicated by the transmission request information, and then transmits the operation screen data to the multifunctional apparatus 1 with use of HTTP (S83).

Next, in the multifunctional apparatus 1, the UI manager 16a of the UI service layer 16 causes the operation panel 6 to display the parameter A input screen for use in an OCR process in accordance with the received operation screen data. Then, when the user inputs a parameter A and press the OK button, the UI manager 16a transmits, to the control apparatus 2, the input parameter A and pressed-button information indicating that the OK button has been pressed (S84).

Subsequently, in the control apparatus 2, the information accepting section 231 reads out, from the pressed button-processing content table, processing content information corresponding to the received pressed-button information, and then provides the UI control section 233 and the application control section with predetermined instructions (S85, S86). It is assumed here that the pressed-button information is correlated with processing content information containing (i) an operation screen changing process of outputting data indicating a parameter B input screen for use in a translation process and (ii) activation of the OCR application.

The application instruction section 236 activates the OCR application, so that an OCR process is executed by using the parameter A transmitted from the multifunctional apparatus 1 (S87).

Concurrently with the OCR process, the UI control section 233 reads out, from the screen data storage section 232, the operation screen data indicating the parameter B input screen for use in a translation process, and then transmits the operation screen data to the multifunctional apparatus 1 (S88). Then, the multifunctional apparatus 1 displays the parameter B input screen.

The user inputs a parameter B to the parameter B input screen for use in a translation process, and then presses the OK button. With this, the UI manager 16a transmits, to the control apparatus 2, the input parameter B and pressed-button information indicating that the OK button has been pressed (S89).

Next, in the control apparatus 2, the information accepting section 231 reads out, from the pressed button-processing content table, processing content information corresponding to the received pressed-button information, and then provides the UI control section 233 and the application control section with predetermined instructions (S90, S91). It is assumed here that the pressed-button information is correlated with processing content information containing (i) an operation screen changing process of outputting data indicating a parameter C input screen for use in a printing process and (ii) a process of executing the translation application.

The application instruction section 236 activates the translation application, so that a process of translating the text data that has been subjected to the OCR process is executed by using the parameter B transmitted from the multifunctional apparatus 1 (S92).

Concurrently with the translation process, the UI control section 233 reads out, from the screen data storage section 232, the operation screen data indicating a parameter C input screen for use in a printing process, and then transmits the operation screen data to the multifunctional apparatus 1 (S93). Then, the multifunctional apparatus 1 displays the parameter C input screen.

The user inputs a parameter C to the parameter C input screen for use in a printing process, and then presses the OK button. With this, the UI manager 16a transmits, to the control apparatus 2, the input parameter C and pressed-button information indicating that the OK button has been pressed (S94).

Next, in the control apparatus 2, the information accepting section 231 reads out, from the pressed button-processing content table, processing information corresponding to the received pressed-button information, and then provides the UI control section 233 and the application control section with predetermined instructions (S95, S96). It is assumed here that the pressed-button information is correlated with processing content information containing (i) an operation screen changing process of outputting data indicating an operation screen “NOW PRINTING” and (ii) a process of executing a print job creation application.

The application control section activates the print job creation application, so that a print job for printing the document containing the translated text data is created by using the parameter C transmitted from the multifunctional apparatus 1 (S97).

Concurrently with the print job creating process, the UI control section 233 reads out, from the screen data storage section 232, the operation screen data indicating the operation screen “NOW PRINTING”, and then transmits the operation screen data to the multifunctional apparatus 1 (S98). Then, the multifunctional apparatus 1 displays the operation screen.

Thereafter, after the end of the process of creating the print job, the print job creation application provides the device control section 235 with an instruction to output a control instruction corresponding to a control content “print” (S99). The device control section 235 reads out, from the control instruction table storage section 234, the control instruction corresponding to the control content “print”, and then sends the control instruction to the multifunctional apparatus 1 with use of SOAP (S100). In so doing, the device control section 235 also transmits the print job.

In the multifunctional apparatus 1, the job manager 17b of the Web service layer 17 receives the control instruction, and then invokes the print application 18b of the OSA application layer 18. Then, the print application 18b outputs, to the Open I/F layer 19, a first API serving as a command to print. The Open I/F layer 19 converts, into a second API acceptable to the service layer 13, the first API sent from the print application 18b, and then sends the second API to the service layer 13. Then, appropriate modules (e.g., the print service, the image processing service, and the like in this case) of the service layer 13 execute printing by using the corresponding elemental functions (S101).

Further, the device control section 235 transmits, to the multifunctional apparatus 1, a control instruction indicating a shift to the initial operation screen (S102). Then, in the multifunctional apparatus 1, based on the received control instruction, the UI manager 17a of the Web service layer 17 provides the UI manager 16a of the UI service layer 16 with an instruction to shift to the initial operation screen. With this, the UI manager 16a of the UI service layer 16 causes the operation panel 6 to shift to the initial operation screen.

(3-5. Concrete Example 4: Event Tabulation Application)

The following describes Concrete Example 4 of the process that is performed in cases where the multifunctional apparatus 1 has URL registration information registered therein and operates in cooperation with an external application in accordance with the URL registration information.

The present concrete example performs such control that in cases where a predetermined event is performed in the multifunctional apparatus 1, job result notification indicating the completion of a job corresponding to that event is transmitted to the control apparatus 2.

In the present concrete example, the multifunctional apparatus 1 cooperates with an event tabulation application of the application section 25 of the control apparatus 2. That is, the control apparatus 2 acquires, from the multifunctional apparatus 1, job result notification notifying a result of the execution of a predetermined event in the multifunctional apparatus 1 (event content information), and tabulates such results.

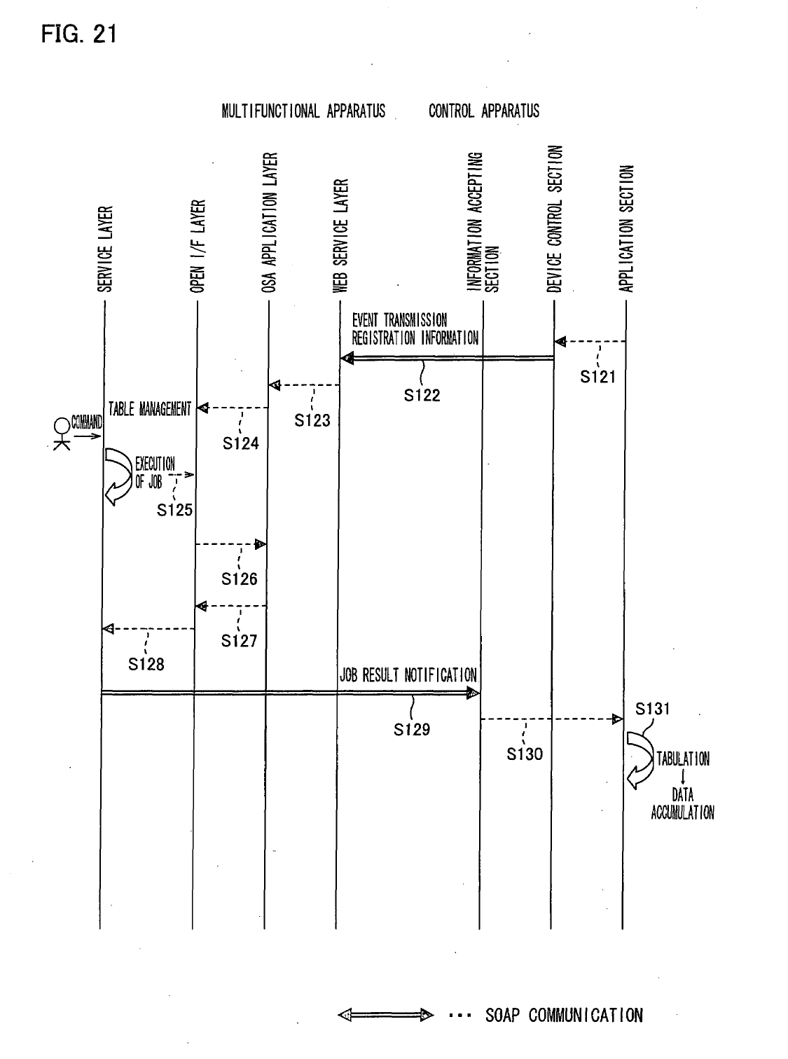

A flow of the process in the concrete example will be described below with reference to FIG. 21.

First, the event tabulation application of the application section 25 of the control apparatus 2 outputs event transmission registration information to the device control section 235 (S121). Then, the device control section 235 sends, to the multifunctional apparatus 1, a registration control instruction to which the event transmission registration information has been added (S122).

It should be noted that the event transmission registration information contains (i) an event item (e.g., an authentication process, a scan process, a copy process, or a process of detecting a pressing of an operation button), (ii) job content to be notified (e.g., completion of a job or occurrence of an error), and (iii) destination information indicating a destination of the event content information.

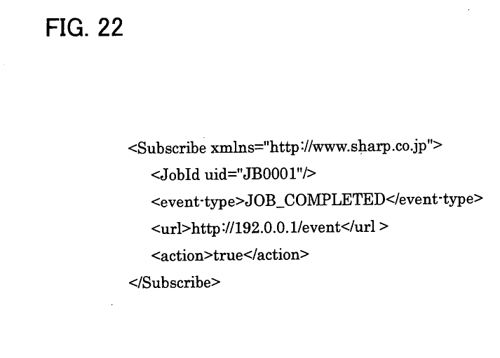

FIG. 22 is a diagram showing an example of the event transmission registration information. The event transmission registration information of FIG. 22 indicates the event item “JB0001”, the job content “JOB_COMPLETED”, and the destination “http://192.0.0.1/event”.

Next, upon receiving the registration control instruction to which the event transmission registration information has been added, the event manager 17c of the Web service layer 17 invokes an event application (not shown) of the OSA application layer 18 (S123).

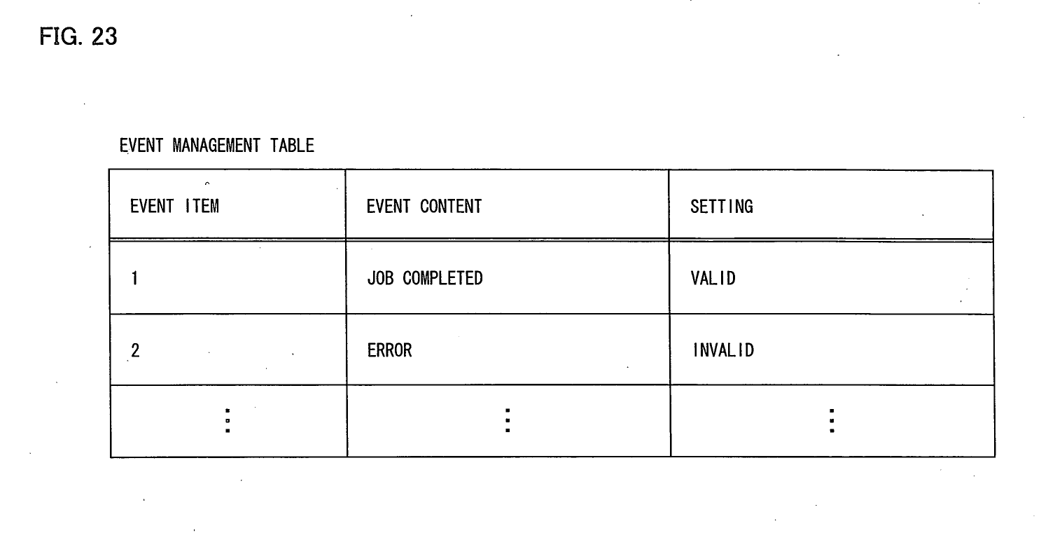

Then, the event application registers the event in the Open I/F layer 19 (S124). That is, the event application outputs the event transmission registration information to the Open I/F layer 19. The Open I/F layer 19 manages the event transmission registration information. That is, in accordance with the event transmission registration information, the Open I/F layer 19 stores, for each piece of destination information, an event management table in which, as shown in FIG. 23, an event item, job content, the presence or absence of notification (valid: notified, invalid: not notified) are correlated with one another. That is, the Open I/F layer 19 includes an event management table storage section (registration information management section; not shown) in which the event management table is stored.

Thereafter, the Open I/F layer 19 monitors an event that occurs in the service layer 13, and judges whether or not an elemental function corresponding to the event content of an event item managed in the event management table has been executed (S125). That is, the Open I/F layer 19 includes judging means (not shown) for judging whether or not an elemental function corresponding to the event content of an event item stored in the event management table storage section has been executed.

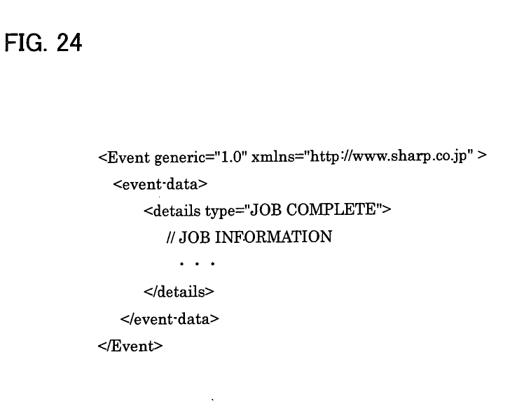

In cases where the event content has been executed, the Open I/F layer 19 outputs, to the OSA application layer 18, job result notification indicating that the event content, corresponding to an event managed in the event management table, which is in the same table has been executed (S126). Then, the OSA application layer 18 creates an event information transmission command (first API) to transmit the job result notification to the control apparatus 2, and sends the event information transmission command to the Open I/F layer 19 (S127). The Open I/F layer 19 reads out, in accordance with the API table, a second API corresponding to the event information transmission command received from the OSA application layer 18, and sends the second API to the service layer 13 (S128). In response to the second API, the service layer 13 transmits, to the control apparatus 2, tabulation processing request information containing the job result notification (S129). FIG. 24 is a diagram showing an example of the job result notification.

In response to the tabulation processing request information, the information accepting section 231 of the control apparatus 2 refers to the processing request-processing content table, and then instructs the application instruction section 236 so that the event tabulation application of the application section 25 activates the process (S130). Then, the event tabulation application tabulates the job result notification in accordance with an instruction given from the application instruction section 236 (S131).

(4. Process of Performing a Display in the Multifunctional Apparatus 1)

(4-1. Process of Displaying an Operation Screen)

The following describes a process that is performed in the UI manager 16a of the multifunctional apparatus 1 so that an operation screen is displayed.

Operation screen data that is transmitted from the UI control section 233 of the control apparatus 2 to the UI service layer 16 of the multifunctional apparatus 1 contains (i) screen style information (screen type information) indicating a screen style (screen format) of an operation screen), (ii) part type information indicating the types (e.g., title, square button, radio button, and check box) of parts (screen parts) that constitute the operation screen, and (iii) sub-information indicating texts on the parts.

Meanwhile, the UI manager 16a of the UI service layer 16 includes a screen table storage section (not shown) in which (a) the screen style information and (b) part display information indicating the display style (shape and size) and location of each of the parts (e.g., title, square button, radio button, and check box) that constitute the screen defined by the screen style are stored so as to be correlated with each other. Then, the UI manager 16a converts the received operation screen data into UI data suitable for the operation panel 6 of the multifunctional apparatus 1.

Specifically, the UI manager 16a extracts the screen style information, the part type information, and the sub-information from the operation screen data.

Then, the UI manager 16a reads out, from the screen table storage section (not shown), the part display information corresponding to the screen style information extracted from the operation screen data, and determines the location of each of the parts in accordance with the order of description of the parts in the operation screen data.

Further, the UI manager 16a reads out, from the screen table storage section (not shown), the part display information corresponding to the screen style information extracted from the operation screen data, and determines the display format of each of the parts in accordance with the part type information extracted from the operation screen data. Furthermore, the UI manager 16a determines, in accordance with the sub-information extracted from the operation screen data, texts to be respectively displayed in the parts. Then, the UI manager 16a creates UI data in accordance with the content of the determinations.

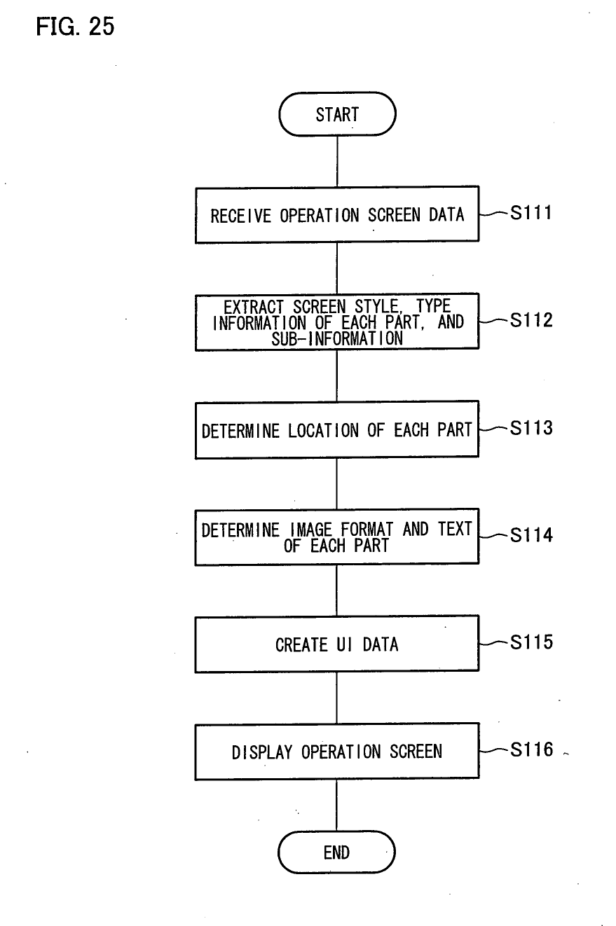

A flow of the process of displaying an operation screen will be fully described below with reference to the flow chart of FIG. 25.

First, the UI manager 16a receives operation screen data from the control apparatus 2 (S111).

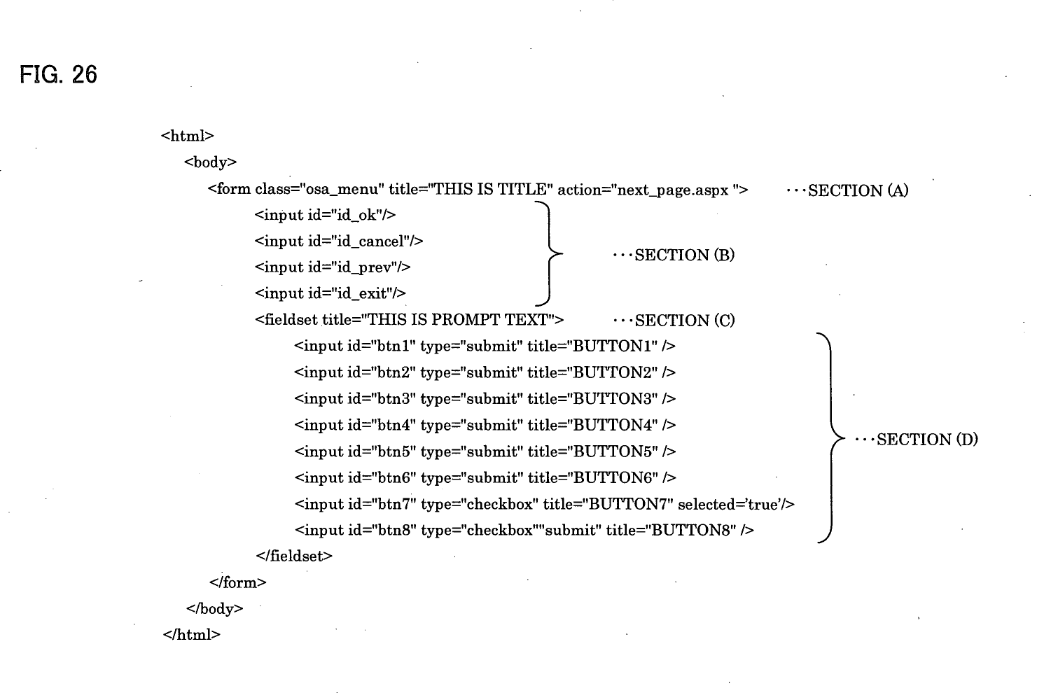

FIG. 26 is a diagram showing an example of the operation screen data transmitted from the control apparatus 2. In FIG. 26, Section (A) designates the design structure and title of the operation screen. It should be noted that “osa_menu” indicates screen style information, which is defined in each multifunctional apparatus 1. In this case, “osa_menu” corresponds to such a screen style that a control button is located in an upper portion of the screen and a content button is located in a lower portion of the screen.

Section (B) designates the control button that is displayed in the upper portion of the operation screen. Section (C) designates the title displayed on the control screen. Section (D) designates the content button. The “type=“submit”” indicates a submit button. The “title” indicates a character string displayed on the button. The “type=“checkbox”” indicates a check box. The “selected=“true”” indicates a style instruction for causing the corresponding button to be selected by default.

Next, the UI manager 16a extracts the screen style information “osa_menu”, part type information, and sub-information from the operation screen data. (S112).

Thereafter, the UI manager 16a reads out, from the screen table storage section (not shown), each piece of part display information corresponding to the screen style information “osa_menu”, and then determines the location of each of the parts in accordance with the order of description of the parts in the operation screen data. (S113).

Furthermore, the UI manager 16a determines a display format in accordance with the part display information and the part type information (“submit” and “checkbox”) extracted from the operation screen data, and also determines, in accordance with the sub-information, texts to be respectively displayed in the parts (S114).

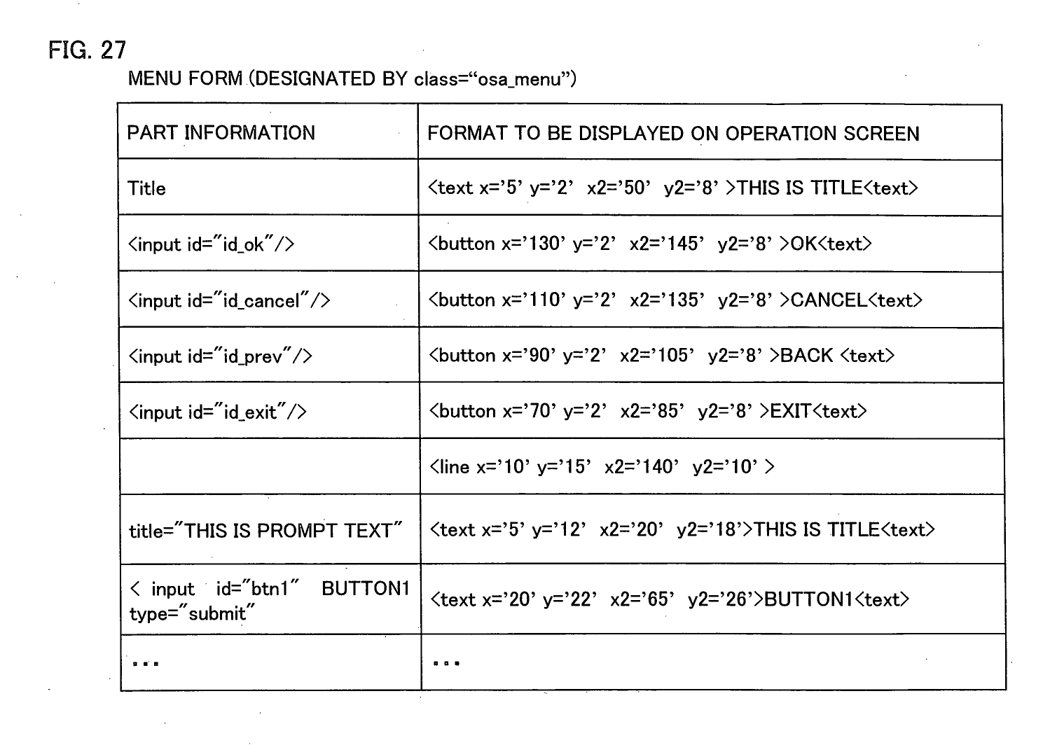

Then, the UI manager 16a creates UI data in accordance with the content of the determinations (S115). For example, the UI manager 16a creates, from the operation screen data of FIG. 26, such UI data as shown in FIG. 27.

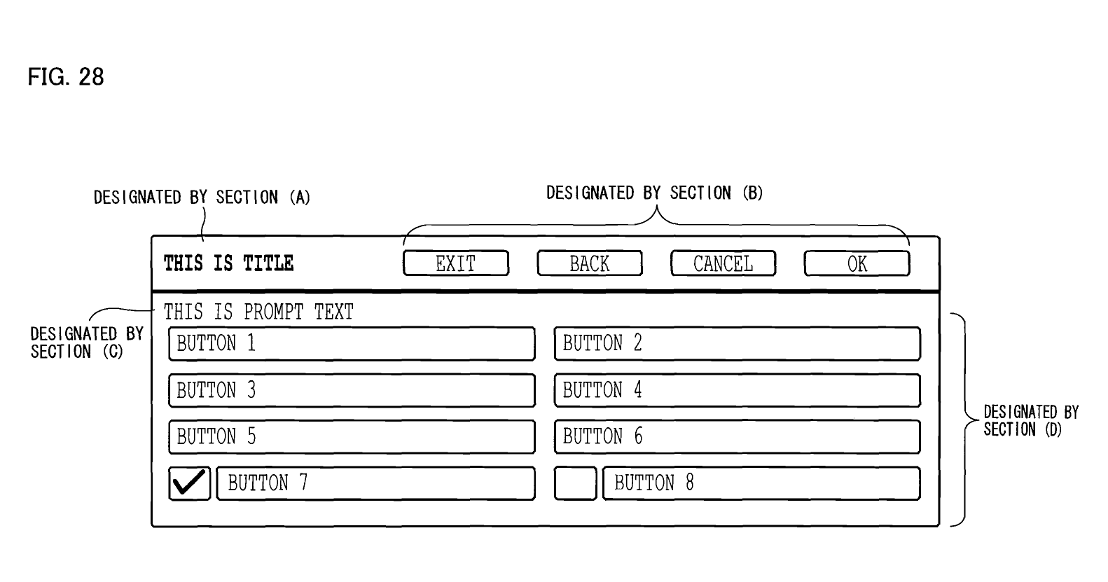

Thereafter, the UI manager 16a causes the operation panel 6 to display an operation screen in accordance with the created UI data (S116). FIG. 28 is a diagram showing an operation screen that is based on the UI data of FIG. 27.

The foregoing description assumes that the OSA application layer 18 creates a first API in accordance with a control instruction received from the control apparatus 2. However, the control apparatus 2 may transmit a first API directly to the multifunctional apparatus 1. In this case, the Open I/F layer 19 only needs to receive a first API directly from the control apparatus 2.

(4-2. Process of Creating Screen Data in Accordance with HTML Page Data)

The following describes a concrete example where the control apparatus 2 acquires online HTML page data, where the creation (formation, conversion) of screen data suitable for being displayed in the multifunctional apparatus 1 is performed in accordance with the acquired HTML page data, and where the created screen data is transmitted to the multifunctional apparatus 1.

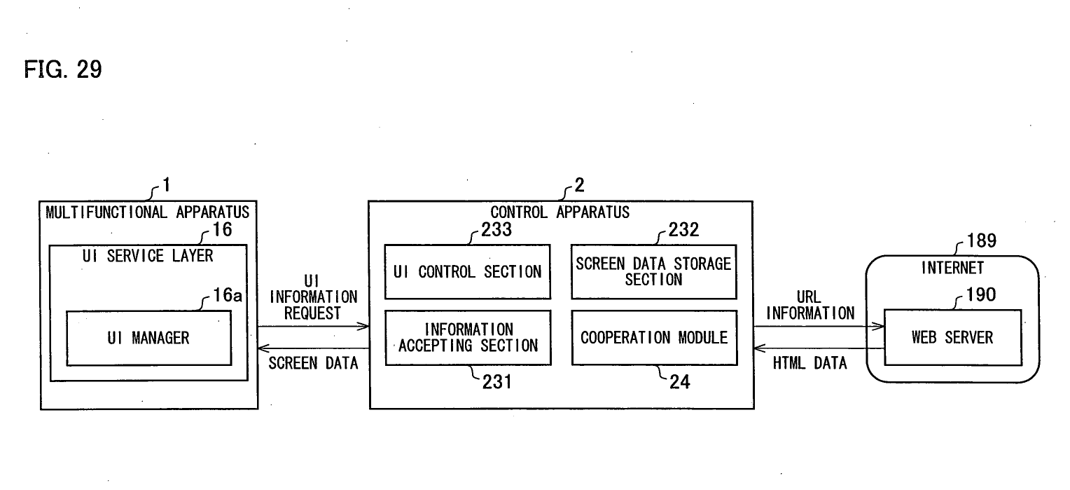

FIG. 29 is a diagram showing a structure of a main part of each of the apparatuses that are used in the present concrete example. As shown in FIG. 29, the multifunctional apparatus 1, which has the UI service layer 16 and the UI manager 16a contained therein, and the control apparatus 2, which has the UI control section 233, the screen data storage section 232, the information accepting section 231, and the cooperation module 24, are connected to each other via a communication network. Further, the control apparatus 2 is connected to a Web server 190, provided on the Internet 189, via a communication network so as to be able to acquire, from the Web server 190, page information corresponding to the designated URL. It should be noted that the screen data storage section 232 stores general-purpose screen data by which online page information is displayed.

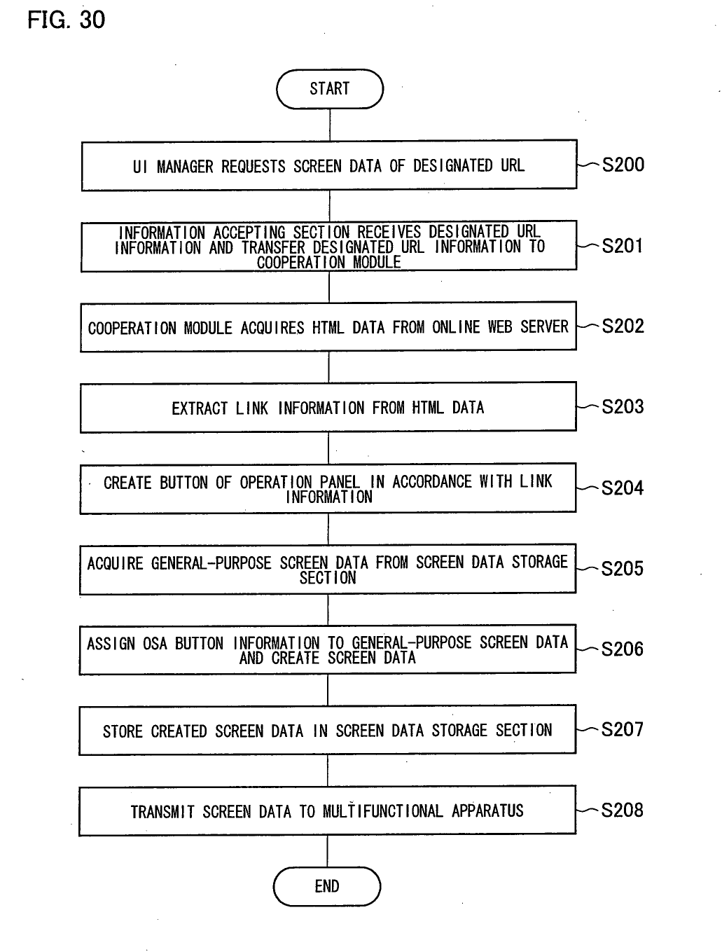

A flow of the process in the present concrete example will be described below with reference to the flow chart of FIG. 30.

First, in the multifunctional apparatus 1, the UI manager 16a of the UI service layer 16 transmits, to the control apparatus 2, a URL information acquisition request for a URL indicated by a user's operation (S200).

Next, in the control apparatus 2, the information accepting section 231 notifies the cooperation module 24 of the URL information acquisition request received from the multifunctional apparatus 1 (S201). Then, the cooperation module 24 reads out, from the Web server 190 provided on the Internet 189, HTML data corresponding to the designated URL page (S202).

Next, the cooperation module 24 extracts link information from the acquired HTML data (S203). This link information contains linked information (linked URL) and a character string that represents the link information.

Next, the cooperation module 24 creates, from the extracted link information, button information to be displayed by the operation panel 6 (S204). Added to the button information are the linked information and the character string that represents the link information.

Next, the cooperation module 24 acquires general-purpose screen data from the screen data storage section 232 (S205), and then creates screen data by assigning the button information to buttons of the general-purpose screen data (S206). It should be noted that the size of the buttons of the general-purpose screen data is set (to be not less than a predetermined size) so that the user can appropriately operate the buttons when the buttons are displayed by the operation panel 6 of the multifunctional apparatus 1. This makes it possible to cause the operation panel 6 of the multifunctional apparatus 1 to display buttons sized so as to be easily operated by the user. This prevents the user from having trouble operating buttons made too small when the HTML data acquired from the Web server 190 is simply reduced in accordance with the size of the operation panel 6 of the multifunctional apparatus 1.

Next, the UI control section 233 saves the created screen data in the screen data storage section 232 so that the screen data can be used as cache information for use in access to the same page (S207). Further, the UI control section 233 transmits the created screen data to the multifunctional apparatus 1 (S208). The UI manager 16a of the multifunctional apparatus 1 notifies the operation panel section 11a of the screen data received from the control apparatus 2, and stores the screen data in the screen table storage section (not shown). The operation panel section 11a causes the operation panel 6 to display the screen data notified from the UI manager 16a.

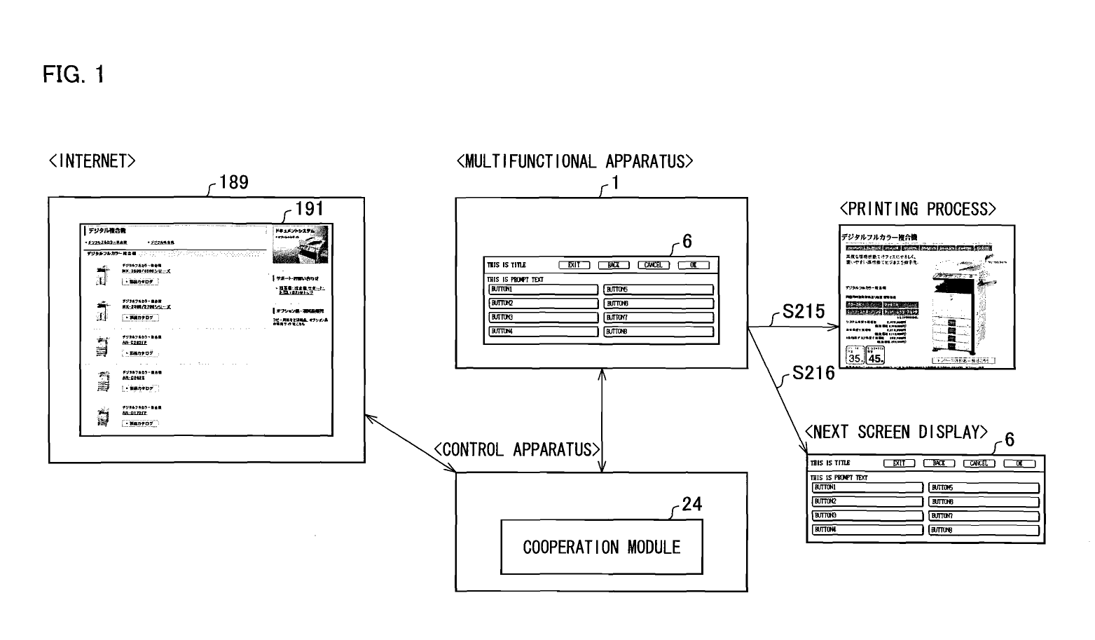

An example of an application using the present concrete example will be described below with reference to FIG. 1.

As shown in FIG. 1, according to the technique of the present concrete example as described above, the control apparatus 2 acquires, from the Web server 190 connected to the Internet 189, HTML data of a Web page 191, creates screen data in accordance with the acquired HTML data and the general-purpose screen data saved in the screen data storage section 232, and transmits the screen data to the multifunctional apparatus 1, so that the screen data is displayed be the operation panel 6 of the multifunctional apparatus 1.

It should be noted, as shown in FIG. 1, that the operation panel 6 displays buttons (BUTTON 1 to BUTTON 8) created from (i) link information acquired from the Web page 191 available through the Internet 189 and (ii) a character string that represents the link information.

The user can operate the buttons thus displayed by the operation panel 6. In this case, it is possible to perform a display for prompting the user to operate the buttons.

On this occasion, various processes can be realized depending on the characteristics of an application. However, the following describes a printing process (S215) of printing a Web page available through the Internet and an operation process (S216) of causing the operation panel 6 to make a transition from the currently displayed screen to a screen corresponding to a linked Web page.

In the printing process (S215), when the user presses any one of the buttons of the operation panel 6, linked information (URL) associated with that button is transferred to the control apparatus 2. It should be noted that the printing process is selected from an operation screen, displayed after (or before) the pressing of the button for specifying the linked information, by which processing content is selected.

The following describes the printing process (S215) more in detail. First, the operation panel section 11a of the user interface layer 11 detects a button that has been pressed, and then notifies the UI manager 16a of the detected button. The UI manager 16a extracts, from screen data stored in the screen table storage section, linked information associated with the notified button, and then transfers the extracted linked information to the control apparatus 2.

Next, the information accepting section 231 of the control apparatus 2 notifies the cooperation module 24 of the linked information transferred from the multifunctional apparatus 1. The cooperation module 24 acquires, from the Web server 190 provided on the Internet 189, HTML data of a Web page represented by the linked information notified from the information accepting section 231, and then transmits the acquired HTML data to the multifunctional apparatus 1. Then, the UI service layer 16 of the multifunctional apparatus 1 notifies the application layer 12 of the received HTML data, and the print application 12b of the application layer 12 performs a process of printing the HTML data.

This makes it possible, for example, to cause the multifunctional apparatus 1 to display a top page of an online portal site and to realize an application that prints linked information selected by using the top page.

In the operation process (S216), when the user presses any one of the buttons of the operation panel 6, linked information (URL) associated with that button is transferred to the control apparatus 2. It should be noted that the operation process is selected in the same manner as the printing process. For example, the operation process is selected from an operation screen, displayed after (or before) the pressing of the button for specifying the linked information, by which processing content is selected.

The following describes the operation process (S216) more in detail. First, the operation panel section 11a of the user interface layer 11 detects a button that has been pressed, and then notifies the UI manager 16a of the detected button. The UI manager 16a extracts, from screen data stored in the screen table storage section, linked information associated with the notified button, and then transfers the extracted linked information to the control apparatus 2. Thereafter, the control apparatus 2 performs the same process as described above in FIG. 30, thereby creating screen data corresponding to the linked Web page (i.e., screen data to be displayed by the operation panel 6 of the multifunctional apparatus 1). Then, the control apparatus 2 transmits the screen data to the multifunctional apparatus 1. The UI manager 16a of the multifunctional apparatus 1 notifies the operation panel section 11a of the screen data received from the control apparatus 2, and also stores the screen data in the screen table storage section (not shown). The operation panel section 11a causes the operation panel 6 to display the screen data notified from the UI manager 16a.

This makes it possible, for example, to track back stratified Web page links on the operation panel 6 and to realize an application or the like that selects and prints page information located in a deep stratum.

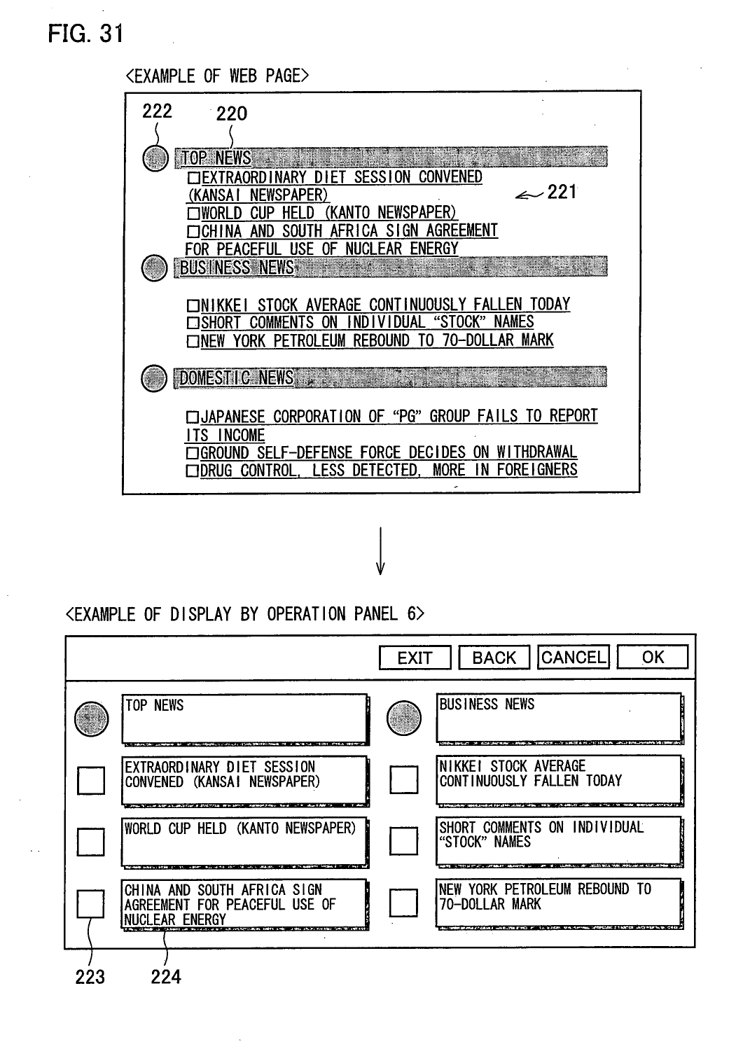

FIG. 31 shows a detailed example of an online Web page and a detailed example of a display screen that is displayed by the operation panel 6 of the multifunctional apparatus 1 in accordance with the Web page.

Such an Internet portal site as shown in FIG. 31 is one of the Web pages most effective in using the present concrete example. This Web page includes categories (220), such as news, each of which has a topic (221) that represents information associated with that category. Further, each of the categories has an icon (222) set on the left side thereof. A clicking of the icon makes a transition to a Web page that shows a larger number of topics. Further, a clicking of a topic makes a transition to a Web page that shows more detailed information on that topic.

The use of the present concrete example makes it possible to acquire a character string and linked information of each category and topic contained in the online Web page and to create, in accordance with the acquired pieces of information, a display screen suitable for the operation panel 6 of the multifunctional apparatus 1 as shown in FIG. 31. In the example shown in FIG. 31, an icon (button) corresponding to the icon (222) contained in the Web page on the Internet is displayed on the left side of an operation button corresponding to each category contained in the Web page.

A pressing of a button displayed on an operation screen of the multifunctional apparatus 1 enables the multifunctional apparatus 1 to acquire, from the Internet, HTML data of a Web page of linked information associated with the button. Therefore, the acquired linked Web page can be printed, and information corresponding to the linked Web page can be displayed on a display screen suitable for the operation panel 6.

According to the example shown in FIG. 31, the display screen displayed by the operation panel 6 of the multifunctional apparatus 1 makes it possible to select a printing process by selecting (pressing) a square button displayed on the left side of a button containing a character string of each topic and to select, by selecting a button containing a character string of each topic, a process of displaying detailed information (linked information) on that topic. Thus, in the example shown in FIG. 31, the switching of processes to be performed can be controlled by a user's operation.

Although the present concrete example assumes that HTML data is acquired from the Internet, the present invention is not limited to this. For example, HTML data may be acquired from other networks such as intranets, or may be read out from various storage media by the control apparatus 2.

(4-3. Process of Dividing Screen Data and Transmitting Divided Screen Data)

The following describes a concrete example of a process of transmitting screen data from the control apparatus 2 to the multifunctional apparatus 1.

The screen data transmitted from the control apparatus 2 contains various pieces of information that constitute a screen. Therefore, depending on what screen is displayed, the screen data contains a large amount of information, and may not be appropriately transmitted. In view of this, the present concrete example calculates, from the speed of communication from the control apparatus 2 to the multifunctional apparatus 1, the size of data transmittable within a predetermined period of time, divides the screen data into pieces of data at the time of transmitting the data so that each of the pieces of data has the calculated size, and transmits the pieces of data. This makes it possible to reduce the amount of information contained in screen data transmitted at a time, thereby making it possible that the screen data can be appropriately transmitted and received by reducing the load at the time of transmission.

In the present concrete example, the UI control section 233 reads out, from the screen data storage section 232, (i) operation screen data corresponding to an instruction accepted by the information accepting section 231 from the multifunctional apparatus 1 and (ii) communication speed data representing a communication speed at which data is transmitted from the control apparatus 2 to the multifunctional apparatus 1, divides the operation screen data into pieces of data in accordance with the communication speed data, and transmits the pieces of data to the multifunctional apparatus 1.

The present concrete example assumes that the communication speed data representing a communication speed at which data is transmitted from the control apparatus 2 to the multifunctional apparatus 1 is stored in advance in the screen data storage section 232. This makes it possible to simplify transmission by omitting a process of calculating the communication speed and to perform good communication by reducing the load at the time of transmission. The communication speed represented by the communication speed data does not need to exactly coincide with the actual communication speed, and the effect of reducing the load at the time of transmission can be obtained even in cases where there is some difference between the communication speed represented by the communication speed data and the actual communication speed. However, it is preferable that the control apparatus 2 and the multifunctional apparatus 1 be connected to each other via a communication network, such as an intranet, whose communication speed is stable. This causes only small variations in communication speed. This makes it possible to perform control more appropriately by reducing the difference between the communication speed represented by the prestored communication speed data and the actual communication speed.

Further, although the present concrete examples assumes that the communication speed data is stored in advance in the screen data storage section 232, the present invention is not limited to this. For example, it is possible to use communication speed data that is obtained by measuring the communication speed every time communication is performed. Examples of the method for measuring the communication speed include conventionally publicly-known various methods.

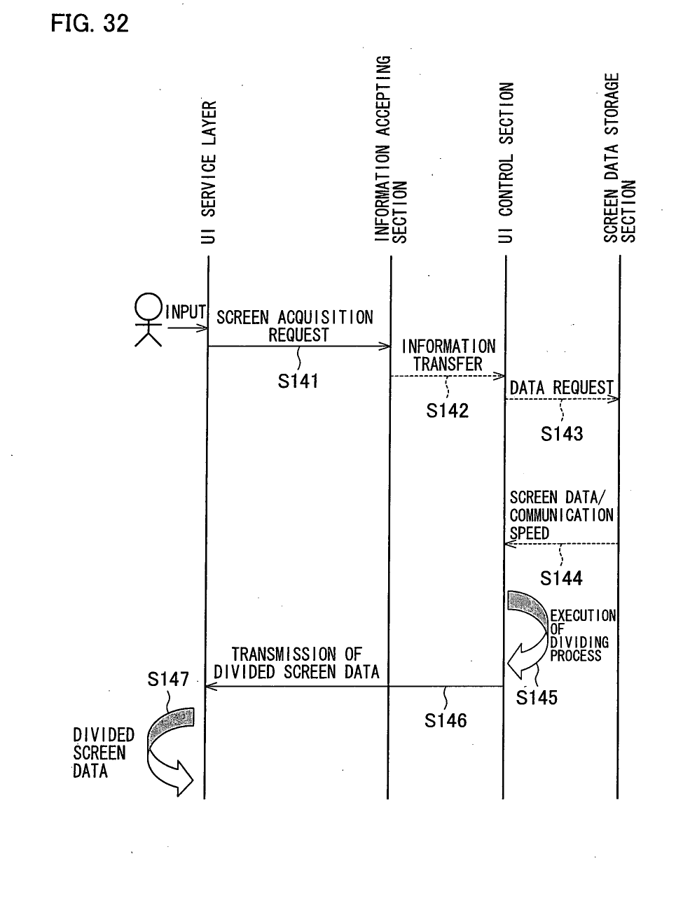

A flow of the process in the present concrete example will be described below with reference to FIG. 32. First, in the multifunctional apparatus 1, the UI manager 16a of the UI service layer 16 transmits, to the control apparatus 2, a screen information acquisition request for screen information associated with the content of a user's operation (S141).

Subsequently, in the control apparatus 2, the information accepting section 231 notifies (information transfer) the UI control section 233 of an acquisition request for (i) screen information data corresponding to the received screen acquisition request and (ii) communication speed data representing a speed of communication between the control apparatus 2 and the multifunctional apparatus 1 (S142). The UI control section 233 requests (data request), from the screen data storage section 232, information corresponding to the notified acquisition request (S143). The screen data storage section 232 sends the requested information to the UI control section 233 (S144). That is, the UI control section 233 reads out, from the screen data storage section 232, the information corresponding to the acquisition request notified from the information accepting section 231.

The UI control section 233 divides the screen data into a plural pieces of screen data with use of the communication speed data as will be described later. At the time of division, the UI control section 233 adds the total number of pieces of screen data and the serial numbers of the pieces of screen data as header information to each screen data (S145). That is, the UI control section 233 assigns the serial numbers respectively to the pieces of screed data, and adds, to header information corresponding to each piece of screen data, the total number of pieces of screen data and a serial number assigned to that pieces of screen data. Then, the UI control section 233 transmits the created pieces of screen data to the multifunctional apparatus 1 (S146).

The multifunctional apparatus 1 sequentially acquires the pieces of screen data. After the multifunctional apparatus 1 has acquired all the pieces of screen data, the multifunctional apparatus 1 restores the original data by combining the pieces of screen data with one another (S147).

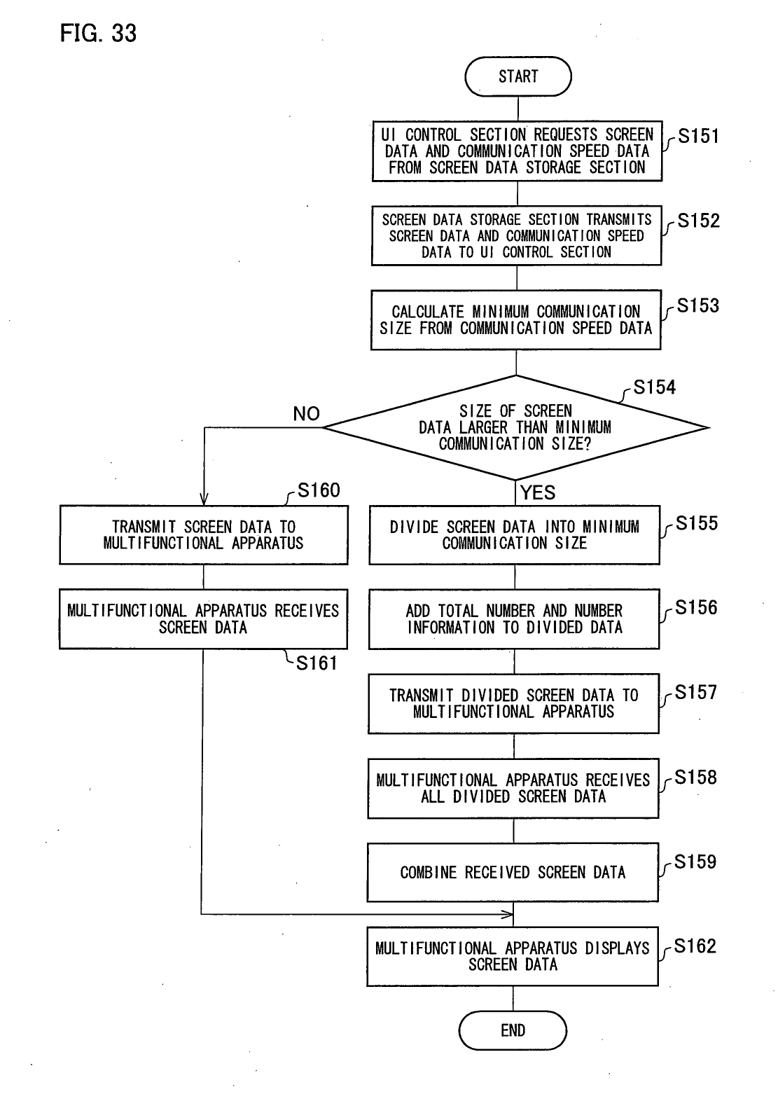

The following describes, with reference to the flow chart of FIG. 33, a method for dividing screen data. FIG. 33 is a flow chart showing a flow of a process that is performed by the control apparatus 2 at the time of transmission of screen data from the control apparatus 2 to the multifunctional apparatus 1.

First, the UI control section 233 sends, to the screen data storage section 232, an acquisition request for screen data designated by the multifunctional apparatus 1 and communication speed data (S151). The screen data storage section 232 sends the designated information to the UI control section 233 (S152).

Next, the UI control section 233 calculates a minimum communication size from the acquired communication speed data (S153). The minimum communication size is set so that a single round of communication is completed within a fixed period of time (e.g., one second). For example, in cases where the communication speed is 1.6 Mbps, the minimum communication size is calculated as 0.2 MB (1 B (byte)=8 b (bit)).

Next, the UI control section 233 judges whether or not the size of the screen data is larger than the minimum communication size (S154). Then, in cases where the UI control section 233 has judged that the size of the screen data is larger than the minimum communication size, the UI control section 233 divides the screen data into pieces of screen data so that the size of each of the pieces of screen data divided from one another is equal to (or not more than) the minimum communication size (S155). Further, the UI control section 233 adds the total number of pieces of screen data and the serial numbers of the pieces of screen data as header information to each piece of screen data (S156). Then, the UI control section 233 sequentially transmits the pieces of screen data to the multifunctional apparatus 1 (S157).

The UI manager 16a of the multifunctional apparatus 1 sequentially receives and acquires the pieces of screen data transmitted from the control apparatus 2 (S158). In so doing, the UI manager 16a checks the total number of pieces of screen data and the serial numbers of the pieces of screen data that are contained in the header information of the piece of screen data, and continues reception until it acquires all the pieces of screen data. Then, when the UI manager 16a has acquired all the pieces of screen data, the UI manager 16a restores the original screen data by combining the pieces of screen data with one another in accordance with the serial numbers respectively assigned to the pieces of screen data (S159). Then, the UI manager 16a sends the restored screen data to the operation panel section 11a, and the operation panel section 11a causes the operation panel 6 to display the screen data (S162).

In cases where the UI control section 233 has judged in S154 that the size of the screen data is not more than the minimum communication size, the UI control section 233 transmits the screen data to the multifunctional apparatus 1 without dividing the screen data (S160). Then, the UI manager 16a of the multifunctional apparatus 1 receives the screen data from the control apparatus 2 (S161) and sends the received screen data to the operation panel section 11a, and the operation panel section 11a causes the operation panel 6 to display the screen data (S162).

As described above, the control apparatus 2 according to the present embodiment acquires, from the Web server 190 connected to a network, HTML data of a Web page available through the network, and creates screen data by converting the acquired HTML data into data displayable by the operation panel 6 of the multifunctional apparatus 1.

This enables the operation panel 6 of the multifunctional apparatus 1 to appropriately display online page information. For example, even in cases where a page to be displayed by the operation panel 6 of the multifunctional apparatus 1 is described by a method other than HTML or where the amount of information displayable by the operation panel 6 of the multifunctional apparatus 1 is smaller than the amount of HTML data acquired from the Web server 190, it is possible to cause the operation panel 6 of the multifunctional apparatus 1 to display the online page information or part of the online page information.

Further, the control apparatus 2 (i) stores, in the screen data storage section 232, general-purpose screen data by which the operation panel 6 displays an image corresponding to a Web page, (ii) creates, as the screen data, an image obtained by pasting, on a button (part image) contained in the general-purpose screen data or in a place adjacent to the button, at least a part of a character string corresponding to character string information contained in link information extracted from the HTML data, and (iii) stores the button and linked information, which is contained in the link information, in the screen data storage section 232 so that the button and the linked information are associated with each other. Further, when the multifunctional apparatus 1 receives an instruction to select a button contained in a display screen displaying screen data received from the control apparatus 2, the multifunctional apparatus 1 transmits, to the control apparatus 2, information that specifies the selected button.

With this, for example, in cases where a reduction of the size of an online page in accordance with the size of the operation panel 6 of the multifunctional apparatus 1 makes it difficult for a user of the multifunctional apparatus 1 to perform an operation of selecting link information, an operation of selecting the button displayed by the operation panel 6 of the multifunctional apparatus 1 can be appropriately performed by the user by appropriately setting the size of the button of the general-purpose screen data. Further, when a button is selected in the multifunctional apparatus 1, information that specifies the selected button is transmitted to the control apparatus 2. In the control apparatus 2, the button and linked information contained in the link information are stored in the screen data storage section 232 so as to be associated with each other. This makes it possible to specify linked information corresponding to the button selected in the multifunctional apparatus 1.

Therefore, by performing an operation of selecting, with use of the operation panel 6 of the multifunctional apparatus 1, a button corresponding to desired link information, the user can make a transition in display state to a display screen corresponding to the desired link information. Further, a process of tracking back Web pages available through the Internet or a plurality of linked images stored in the Web server 190 connected to a network can be realized with use of the operation panel 6 of the multifunctional apparatus 1.

Further, the control apparatus 2 calculates, in accordance with communication speed data representing a speed of communication between the control apparatus 2 and the multifunctional apparatus 1, a size of data transmittable per predetermined period of time, divides the screen data into pieces of data so that each of the pieces of data has a size of not larger than the calculated size, and transmits each the pieces of data to the multifunctional apparatus 1. Then, the multifunctional apparatus 1 restores the original screen data by combining the pieces of data separately transmitted from the control apparatus 1, and causes the operation panel 6 to display the restored screen data.

This makes it possible to reduce the load at the time of transmission by reducing the amount of screen data to be transmitted as a time. This makes it possible to appropriately transmit the screen data. Further, user-friendliness can be improved by shortening a period of time between the start of transmission of the screen data from the control apparatus 2 to the multifunctional apparatus 1 and the display of the screen data by the operation panel 6 of the multifunctional apparatus 1.

Further, the control apparatus 2 stores (caches) the created screen data in the screen data storage section. With this, the same Web page can be browsed again without performing a process of acquiring HTML data from the Web server 190 and a process of creating screen data from the HTML data. This makes it possible to increase the speed of a transition from one page to another.

Further, the multifunctional apparatus 1 according to the present embodiment realizes an apparatus function by executing an appropriate combination of a plurality of elemental functions such as a scan function (image reading function), a print function (image forming function), and a communication function. Moreover, the multifunctional apparatus 1 includes: a service layer (elemental function executing means) for executing the plurality of elemental functions; an API table storage section (storage section provided in an Open I/F layer 19; corresponding to a command storage section) for storing an API table that correlates, with a first API (first control command) for executing the apparatus function, a second API (second control command) acceptable to the service layer 13; and an Open I/F layer (control command converting means) 19 for (i) accepting the first API, (ii) specifying, from the API table, a second API corresponding to the first API, and outputting the specified second API to the service layer 13.

As shown in FIG. 9, the service layer 13 is usually arranged so as to be unique to the multifunctional apparatus 1. Therefore, the second API acceptable to the service layer 13 varies depending on the type of multifunctional apparatus 1.

However, according to the foregoing arrangement, the Open I/F layer 19 (i) accepts the first API, (ii) specifies, from the API table, a second API corresponding to the first API, and (iii) outputs the specified second API to the service layer 13. With this, even when the second API depends on the type of multifunctional apparatus 1 as described above, the first API acceptable to the Open I/F layer 19 can be made independent of the type of multifunctional apparatus 1.

With this, in cases where the multifunctional apparatus 1 is controlled by an external control apparatus 2, the control apparatus 2 only needs to output, to the multifunctional apparatus 1, either a first API independent of the type of multifunctional apparatus 1 or a control instruction on which the first API is based. As a result, it is only necessary to develop the control apparatus 2 so that even in cases where the control apparatus 2 performs new control with respect to the multifunctional apparatus 1, the control apparatus 2 creates either a common first API regardless of the type of multifunctional apparatus 1 or a control instruction on which the first API is based. This makes it easy to improve efficiency in development of the control apparatus 2.

Furthermore, the multifunctional apparatus 1 includes: a Web service layer (control instruction accepting means) 17 for accepting a control instruction from the control apparatus 2 via a communication network; and an OSA application layer (apparatus function control means) 18 for creating, in accordance with the control instruction accepted by the Web service layer 17, a first API for executing the apparatus function, and for sending the created first API to the Open I/F layer 19.

As described above, the first API can be made common regardless of the type of multifunctional apparatus 1. Therefore, the OSA application layer 18 can also be arranged so as to be common regardless of the type of multifunctional apparatus 1. This improves efficiency in development of the multifunctional apparatus 1.

Further, in cases where an operation screen is used for controlling the OSA application layer 18, such operation screens are made identical or similar regardless of the type of multifunctional apparatus 1. This is because the OSA application layer 18 does not depend on the type of multifunctional apparatus 1. As a result, users of different types of multifunctional apparatus 1 operate identical operation screens. This improves user-friendliness.

Moreover, since the OSA application layer 18 does not depend on the type of multifunctional apparatus 1, the control instruction acceptable to the OSA application layer 18 also does not depend on the type of multifunctional apparatus 1. Therefore, the control apparatus 2 only needs to output, to the multifunctional apparatus 1, a control instruction that does not depend on the type of multifunctional apparatus 1. As a result, it is only necessary to develop the control apparatus 2 so that even in cases where the control apparatus 2 performs new control with respect to the multifunctional apparatus 1, the control apparatus 2 creates either a common first control command regardless of the type of multifunctional apparatus 1 or a control instruction on which the first control command is based. This makes it easy to improve efficiency in development of the control apparatus 2.

Furthermore, in cases where a plurality of second APIs are stored in the API table so as to be correlated with a single first API, an order in which the plurality of second APIS are outputted is stored in the API table. The Open I/F layer 19 sequentially outputs the plurality of second APIs in accordance with the order.

In case of an apparatus function executed by combining a plurality of elemental functions, the apparatus function cannot be properly realized without determining an appropriate order in which the elemental functions are executed. However, according to the foregoing arrangement, the apparatus function can be properly realized since the plurality of second APIs are outputted in accordance with the order stored in the API table.

Furthermore, the control apparatus 2 creates a control instruction that contains at least one of job creation, execution parameter setting, job execution, job stoppage, job cancellation, and job completion with respect to at least one of copying, scanning, printing, and image transmission. This enables the external control apparatus 2 to control the multifunctional apparatus 1 so that the multifunctional apparatus 1, e.g., executes, stops, and completes a job such as copying.

Furthermore, the control apparatus 2 creates a control instruction that contains a transmission request for event information indicating a result of an event item selected from among a plurality of event items including (i) job execution of at least one of copying, scanning, printing, and image transmission, (ii) button operation at least one of copying, scanning, printing, and image transmission, (iii) login at least one of copying, scanning, printing, and image transmission, and (iv) logout at least one of copying, scanning, printing, and image transmission. Moreover, the multifunctional apparatus 1 includes: an event management table storage section (not shown) (registration information management section) storing an event management table in which event items (as well as event contents) and destinations each contained in the transmission request are correlated with one another; and judging means (provided in the Open I/F layer 19) (not shown) for judging whether or not an elemental function corresponding to an event item (as well as an event content) of the event management table has been executed by a service. In cases where it has been judged by the judging means that an elemental function corresponding to an event item of the event management table has been executed, the OSA application layer 18 specifies, from the event management table, a destination corresponding to the event item. Then, the OSA application layer 18 creates, as the first API, an event information transmission command by which the event information indicating a result of the event item is transmitted to the specified destination.

The foregoing arrangement enables the external control apparatus 2 to tabulate results of events having occurred in the multifunctional apparatus 1. In so doing, the control apparatus 2 requests the multifunctional apparatus 1 to transmit only an event item necessary for tabulation. When an elemental function corresponding to the event item has been executed, the control apparatus 2 can receive event information indicating a result of the event item. With this, the control apparatus 2 can acquire only event information on a necessary event item simply by a transmission request as soon as the event item has occurred. As a result, the control apparatus 2 can tabulate current event information accurately.

Furthermore, the apparatus function includes a function of controlling whether the elemental function is valid or invalid, and the Web service layer 17 accepts, as the control instruction, a validation/invalidation switching instruction to switch between validation and invalidation of each elemental function. This enables the control apparatus 2 to perform such control as to switch between validation and invalidation of an elemental function of the multifunctional apparatus 1.

Furthermore, the multifunctional apparatus 1 includes: an operation panel (display section) 6; and a UI service layer (UI processing means) 16 for causing the operation panel 6 to display an operation screen for the control apparatus 2 to create the control instruction. The UI service layer 16 (i) transmits, to the control apparatus 2, transmission request information (request information) for requesting operation screen data of the operation screen, (ii) acquires the operation screen data from the control apparatus 2 as a response to the transmission request information, and (iii) causes the operation panel 6 to display the operation screen that is based on the acquired operation screen data. Furthermore, the UI service layer 16 transmits, to the control apparatus 2, information inputted to the operation screen.

Meanwhile, the control apparatus 2 includes: an information accepting section (request information accepting means) 231 for accepting the transmission request information from the multifunctional apparatus 1; a UI control section (screen data transmitting means) 233 for transmitting, to the multifunctional apparatus 1, the operation screen data corresponding to the transmission request information accepted by the information accepting section 231; and a device control section (control instruction transmitting means) 235 (i) for creating, in accordance with pressed-button information (operation input information) inputted to the operation screen corresponding to the operation screen data transmitted by the UI control section 233, a control instruction for controlling the multifunctional apparatus 1, and (ii) for transmitting the control instruction to the multifunctional apparatus 1.

With this, the multifunctional apparatus 1 does not need to manage operation screen data of an operation screen, and only needs to request operation screen data of an operation from the control apparatus 2 as needed. As a result, new control of the multifunctional apparatus 1 by the control apparatus 2 can be developed without the need to incorporate operation screen data of an operation screen into the multifunctional apparatus 1. This further improves efficiency in development.

Then, the UI service layer 16 transmits, to the control apparatus 2, information inputted to the operation screen. This enables the device control section 235 of the control apparatus 2 to create a control instruction in accordance with the information inputted to the operation screen.

Further, the UI service layer 16 transmits and receives the transmission request information and the operation screen data by a first communication method (first communication protocol) different from a second communication method (second communication protocol) by which the Web service layer 17 accepts the control instruction. That is, the information accepting section 231 and the UI control section 233 receive and transmit the transmission request information and the operation screen data, respectively, by a first method different from a second communication method by which the device control section 235 transmits the control instruction.

For example, the first communication method is HTTP or HTTPS, and the second communication method is SOAP.

The foregoing arrangement makes it possible to adopt, as the first communication method, a communication method (e.g., HTTP) suitable for transmitting and receiving transmission request information for requesting operation screen data and the operation screen data, and to adopt, as the second communication method, a communication method (e.g., SOAP) suitable for transmitting and receiving the control request.

HTTP has been typically used for communications between a client device and a service device, for the purpose of browsing through Web pages and the like. Using HTTP also for transmission of operation screen data of an operation screen makes it possible to easily construct the UI processing means, for example, by a general-purpose Web browser.

Further, HTTP has limitations in the processing contents of commands such as “get” and “put”. For this reason, as to the control instruction, the use of a communication method (communication protocol) such as SOAP makes it possible to perform various processes.

The operation screen is a login data input screen for inputting user information by which users are identified. The UI service layer 16 transmits, to the control apparatus 2, the user information having been input to the login data input screen. As the control instruction, the Web service layer 17 receives the validation/invalidation switching instruction corresponding to the user information having been transmitted from the UI service layer 16, and the OSA application layer 18 creates, in response to the validation/invalidation switching instruction, a first API for switching between the validation and invalidation of each elemental function.

In order to enable the multifunctional apparatus 1 to perform a user authorization process, it has conventionally been necessary to incorporate, into the multifunctional apparatus 1, registration information, program, and the like, all of which are used for the user authentication process. In this case, since the multifunctional apparatus 1 has other various arrangements, the arrangement for use in the user authentication process is limited (e.g., in terms of database capacity). This raises the possibility of a limitation to the number of registrations.

According to the foregoing arrangement, simply by requesting, acquiring, and displaying an input screen and transmitting the input user information, the multifunctional apparatus 1 can receive an instruction to switch between the validation and invalidation of an elemental function corresponding to a user indicated by the user information. That is, the user authentication process is executed not in the multifunctional apparatus 1 but in the control apparatus 2. This makes it unnecessary to incorporate, into the multifunctional apparatus 1, the arrangement for use in the user authorization process. The control apparatus 2 is provided outside the multifunctional apparatus 1, and is not limited in terms of the arrangement for use in the user authorization process as with the multifunctional apparatus 1. This eliminates conventional problems such as limitation to the number of registrations.

Furthermore, the multifunctional apparatus 1 includes a URL registration information storage section (operation screen identification information storage section) (not shown) in which, with respect to each of a plurality of such control instructions, URLs (operation screen identification information) for identifying an operation screen for creating the control instructions is stored. The UI service layer 16 selects a single URL from the URL registration information storage section, and transmits transmission request information for requesting operation screen data of an operation screen indicated by the selected URL.

This makes it unnecessary for the user to input a URL every time he/she causes an operation screen to be displayed.

Further, the operation screen data contains (i) screen style information (screen type information) indicating a screen format (screen style) of the operation screen and (ii) part type information indicating types of parts that constitute the operation screen. Moreover, the UI service layer 16 includes a screen table storage section (not shown) in which the screen style information and part display information indicating the locations and display formats of the image parts in the operation screen, displayed by the operation panel 6, whose screen format is indicated by the screen style information, are stored so as to be correlated with each other. The UI service layer 16 reads out, from the screen table storage section, part display information corresponding to the screen type information contained in the operation screen data acquired from the control apparatus 2, creates an operation screen in accordance with the part display information and the part type information contained in the operation screen data acquired from the control apparatus 2, and causes the operation panel 6 to display the operation screen.

This allows the control apparatus 2 to create, independently of the type of multifunctional apparatus 1, operation screen data containing the screen type information and the part type information. This results in improved efficiency in development of the operation screen data.

Furthermore, the multifunctional apparatus 1 may include a UI manager (registration/editing means) 17a which, in response to a request sent from an external apparatus, stores new URL registration information in the URL registration information storage section and/or edits the URL registration information stored in the URL registration information storage section. This enables an external apparatus to register, edit, and/or delete URL registration information.

Furthermore, the multifunctional apparatus 1 may include a status manager (notifying means) 17d which, in response to a request sent from an external apparatus, notifies the external apparatus of the URL registration information stored in the URL registration information storage section.

The foregoing arrangement makes it possible to receive, from a multifunctional apparatus 1 that has already been used, URL registration information registered in the multifunctional apparatus 1. This enables a user who has purchased a new multifunctional apparatus 1 to acquire URL registration information from another multifunctional apparatus 1 that has already been used, and to store the URL registration information in the newly-purchased multifunctional apparatus 1. As a result, the user can easily register the URL registration information in the newly-purchased multifunctional apparatus 1.

Further, although the present embodiment describes an example where the operation panel 6 of the multifunctional apparatus 1 displays screen data transmitted from the control apparatus 2, the present invention is not limited to this. For example, the screen data transmitted from the control apparatus 2 may be displayed by a display section provided in a terminal apparatus (e.g., a portable terminal such as a portable phone or a PDA mobile terminal; or a household electrical appliance such as a fax machine or refrigerator) other than the multifunctional apparatus 1.

Further, each of the blocks of the multifunctional apparatus 1 and the control apparatus 2 may be constituted by hardware logic, or may be constituted by software with use of a CPU as described below.

That is, the multifunctional apparatus 1 and the control apparatus 2 have: (i) the CPU (central processing unit) for executing an instruction of control program realizing various functions; (ii) a ROM (read only memory) storing the program; (iii) a RAM (random access memory) for expanding the program; (iv) a storage device (storage medium) such as a memory storing the program and various data; and (v) the like. The object of the present invention also can be achieved by (i) providing, for the multifunctional apparatus 1 and the control apparatus 2, a storage medium storing, in a computer readable manner, a program code (executable program; intermediate code; source program) of the control program for the present system, and (ii) causing a computer (CPU or MPU) to read and execute the program code stored in the storage medium, the program code being the software realizing the aforementioned functions.

Examples of the storage medium are: (i) tapes such as a magnetic tape and a cassette tape; (ii) magnetic disks such as a floppy (disk and a hard disk; (iii) optical disks such as a compact disk read only memory (CD-ROM), a magnetic optical disk (MO), a mini disk (MD), a digital video disk (DVD), and a CD-Rewritable (CD-R); (iv) cards such as an IC card (inclusive of a memory card) and an optical card; and (v) semiconductor memories such as a mask ROM, an EPROM (electrically programmable read only memory), an EEPROM (electrically erasable programmable read only memory), and a flash ROM.

Further, the multifunctional apparatus 1 and the control apparatus 2 may be connectable to the communication network, and the program code may be supplied via the communication network. The communication network is not particularly limited. Specific examples thereof are: the Internet, Intranet, Extranet, LAN (local area network), ISDN (integrated services digital network), VAN (value added network), CATV (cable TV) communication network, virtual private network, telephone network, mobile communication network, satellite communication network, and the like. Further, the transmission medium constituting the communication network is not particularly limited. Specific examples thereof are: (i) a wired channel using an IEEE 1394, a USB (universal serial bus), a power-line communication, a cable TV line, a telephone line, an ADSL line, or the like; or (ii) a wireless communication using IrDA, infrared rays used for a remote controller, Bluetooth®, IEEE 802.11, HDR (High Data Rate), a mobile phone network, a satellite connection, a terrestrial digital network, or the like. Note that, the present invention can be realized by (i) a carrier wave realized by electronic transmission of the program code, or (ii) a form of a series of data signals.

In order to solve the foregoing problems, a control apparatus of the present invention is a control apparatus, including transmitting means for transmitting screen data to a terminal apparatus communicably connected to the control apparatus, which causes a display section of the terminal apparatus to display the screen data, the control apparatus including: data acquisition means for acquiring, from a server apparatus connected to a network, HTML data of a page available through the network; and screen data creating means for creating the screen data by converting the HTML data into data displayable by the display section.

Further, a display system of the present invention is a display system having (i) a terminal apparatus that includes a display section and (ii) a control apparatus that transmits screen data to the terminal apparatus and causes the display section of the terminal apparatus to display the transmitted screen data, the control apparatus including: data acquisition means for acquiring, from a server apparatus connected to a network, HTML data of a page available through the network; and screen data creating means for creating the screen data by converting the HTML data into data displayable by the display section, the terminal apparatus including receiving means for receiving the screen data transmitted from the control apparatus, the terminal apparatus causing the display section to display the received screen data.

Further, a display method of the present invention is a display method for use in a display system, having (i) a terminal apparatus that includes a display section and (ii) a control apparatus communicably connected to the terminal apparatus, which causes the display section to display screen data transmitted from the control apparatus to the terminal apparatus, the display method including: a data acquisition step in which the control apparatus acquires, from a server apparatus connected to a network, HTML data of a page available through the network; a screen data creating step in which the control apparatus creates the screen data by converting the HTML data into data displayable by the display section; a transmitting step in which the control apparatus transmits the created screen data to the terminal apparatus; a receiving step in which the terminal apparatus receives the screen data transmitted from the control apparatus; and a display step in which the terminal apparatus causes the display section to display the received screen data.

According to the foregoing arrangement, the data acquisition means acquires, from the server apparatus connected to the network, the HTML data of the page available through the network, and the screen data creating means creates the screen data by converting the HTML data into data displayable by the display section. This enables the display section of the terminal apparatus to appropriately display the online page information. For example, even in cases where a page to be displayed by the display section of the terminal apparatus is described by a method other than HTML or where the amount of information displayable by the display section of the terminal apparatus is smaller than the amount of HTML data stored in the server apparatus, it is possible to cause the display section of the terminal apparatus to display the online page information or part of the online page information.

Further, the control apparatus may be arranged so as to further include: a screen data storage section in which general-purpose screen data to be displayed by the display section is stored; and extracting means for extracting link information from the HTML data, the link information containing (i) character string information associated with the link information and (ii) linked information for specifying a linked page, wherein the screen data creating means (a) creates, as the screen image, an image obtained by pasting, on a part image contained in the general-purpose screen data or in a place adjacent to the part image contained in the general-purpose screen data, at least a part of a character string corresponding to the character string information contained in the link information extracted by the extracting means, and (b) stores the part image and the linked information in the screen data storage section so that the part image and the linked information are associated with each other.

Further, a terminal apparatus of the present invention is a terminal apparatus including (i) receiving means for receiving screen data transmitted from a control apparatus and (ii) a display section for displaying the screen data, the terminal apparatus including: accepting means for accepting an instruction to select a part image contained in a display screen displaying the screen data; and transmitting means for transmitting, to the control apparatus, information for specifying the selected part image.

The control apparatus prestores, in a screen data storage section, general-purpose screen data for the display section of the terminal apparatus to display. Moreover, the screen data creating means creates, as the screen data, an image obtained by pasting, on a part image contained in the general-purpose screen data or in a place adjacent to the part image contained in the general-purpose screen data, at least a part of a character string corresponding to the character string information contained in the link information extracted by the extracting means.

With this, for example, in cases where a reduction of the size of an online page image in accordance with the size of the display section of the terminal apparatus makes it difficult for a user of the terminal apparatus to perform an operation of selecting link information, an operation of selecting the part mage displayed by the display section of the terminal apparatus can be appropriately performed by the user by appropriately setting the size of the part image of the general-purpose screen data.

Further, when the accepting means of the terminal apparatus accepts an instruction to select the part image contained in the display screen displaying the screen data, the transmitting means of the terminal apparatus transmits, to the control apparatus, the information for specifying the selected part image. In the control apparatus, the part image and linked information contained in the link information are stored in the screen data storage section so as to be associated with each other. Therefore, when the information specifying the selected part image is accepted from the terminal apparatus, it is possible to specify linked information corresponding to the part information.

Therefore, by performing an operation of selecting, with use of the display section of the terminal apparatus, a part image corresponding to desired link information, the user can make a transition in display state to a display screen corresponding to the desired link information. Further, a process of tracking back online, e.g., pages available through the Internet or a plurality of linked images stored in a server apparatus can be realized with use of the display section of the terminal apparatus.

Further, the control apparatus may be arranged so as to further include a screen data storage section in which the screen data is stored, wherein the screen data creating means stores the created screen data in the screen data storage section.

According to the foregoing arrangement, since the created screen data is stored in the screen data storage section, the same page can be browsed again without performing a process of acquiring HTML data from a server apparatus and a process of creating screen data from HTML data. This makes it possible to increase the speed of a transition from one page to another.

Further, the control apparatus may be arranged so as to further include accepting means for accepting, from the terminal apparatus, information for specifying a page available through a network, wherein the data acquisition means acquires HTML data of the page specified by the information accepted by the accepting means.

Further, a terminal apparatus of the present invention is a terminal apparatus including (i) receiving means for receiving screen data transmitted from a control apparatus and (ii) a display section for displaying the screen data, the terminal apparatus including: designated page accepting means for accepting, from a user, designation of a desired page available through a network; and transmitting means for transmitting, to the control apparatus, information for specifying the designated page.

The foregoing arrangement makes it possible to use the terminal apparatus to designate an online page, and to use the display section of the terminal apparatus to browse and/or operate information corresponding to the designated page.

Further, the control apparatus may be arranged such that: the transmitting means (i) calculates, in accordance with communication speed data representing a speed of communication from the control apparatus to the terminal apparatus, a size of data transmittable per predetermined period of time, (ii) divides the screen data into pieces of data so that each of the pieces of data has a size of not larger than the calculated size, and (iii) transmits each of the pieces of data to the terminal apparatus.

Further, the control apparatus of the present invention may be arranged so as to be a control apparatus, including transmitting means for transmitting screen data to a terminal apparatus communicably connected to the control apparatus, which causes a display section of the terminal apparatus to display the screen data, wherein the transmitting means (i) calculates, in accordance with communication speed data representing a speed of communication from the control apparatus to the terminal apparatus, a size of data transmittable per predetermined period of time, (ii) divides the screen data into pieces of data so that each of the pieces of data has a size of not larger than the calculated size, and (iii) transmits each of the pieces of data to the terminal apparatus.

Further, the terminal apparatus of the present invention is a terminal apparatus including (i) receiving means for receiving screen data transmitted from a control apparatus and (ii) a display section for displaying the screen data, wherein the receiving means receives pieces of data obtained by dividing the screen data and transmitted from the control apparatus, the terminal apparatus including combining means for restoring the original screen data by combining the pieces of data with one another, the terminal apparatus causing the display section to display the restored screen data.

Further, the display system of the present invention may be arranged so as to be a display system having (i) a terminal apparatus that includes a display section and (ii) a control apparatus that transmits screen data to the terminal apparatus and causes the display section of the terminal apparatus to display the transmitted screen data, wherein: the control apparatus includes transmitting means that (i) calculates, in accordance with communication speed data representing a speed of communication from the control apparatus to the terminal apparatus, a size of data transmittable per predetermined period of time, (ii) divides the screen data into pieces of data so that each of the pieces of data has a size of not larger than the calculated size, and (iii) transmits each of the pieces of data to the terminal apparatus; and the terminal apparatus includes (a) receiving means for receiving each of the pieces of data transmitted from the control apparatus and (b) a combining means for restoring the original screen data by combining the pieces of data with one another, and causes the display section to display the restored screen data.

Further, the display method of the present invention may be arranged so as to be a display method for use in a display system, having (i) a terminal apparatus that includes a display section and (ii) a control apparatus communicably connected to the terminal apparatus, which causes the display section to display screen data transmitted from the control apparatus to the terminal apparatus, the display method including: a calculation step in which the control apparatus calculates, in accordance with communication speed data representing a speed of communication from the control apparatus to the terminal apparatus, a size of data transmittable per predetermined period of time; a dividing step in which the control apparatus divides the screen data into pieces of data so that each of the pieces of data has a size of not larger than the calculated size; a transmitting step in which the control apparatus transmits each of the pieces of data to the terminal apparatus; a receiving step in which the terminal apparatus receives each of the pieces of data transmitted from the control apparatus; a combining step in which the terminal apparatus restores the original screen data by combining the pieces of data with one another; and a display step of causing the display section to display the restored screen data.

In cases where the size of screen data to be transmitted from the control apparatus to the terminal apparatus is too large, the screen data may not be transmitted appropriately. On the other hand, according to the foregoing arrangement, the transmitting means (i) calculates, in accordance with communication speed data representing a speed of communication from the control apparatus to the terminal apparatus, a size of data transmittable per predetermined period of time, (ii) divides the screen data into pieces of data so that each of the pieces of data has a size of not larger than the calculated size, and (iii) transmits each of the pieces of data to the terminal apparatus. This makes it possible to reduce the load at the time of transmission by reducing the amount of screen data to be transmitted at a time. This makes it possible to appropriately transmit the screen data. Further, user-friendliness can be improved by shortening a period of time between the transmission of the screen data from the control apparatus and the display of the screen data by the display section of the terminal apparatus.

Further, the terminal apparatus includes: the receiving means for receiving the pieces of data obtained by dividing the screen data and transmitted from the control apparatus; the combining means for restoring the original screen data by combining the pieces of data with one another; and the display section for displaying the restored screen data. This makes it possible to appropriately display screen data divided by and transmitted from the control apparatus.

Further, any one of such control apparatuses as described above may be arranged so as to further include: request information accepting means for accepting, from the terminal apparatus, request information for requesting screen data of an operation screen; screen data transmitting means for transmitting, to the terminal apparatus, the screen data corresponding to the request information accepted by the request information accepting means; and control instruction transmitting means (i) for creating, in accordance with operation input information inputted to the operation screen corresponding to the screen data transmitted by the screen data transmitting means, a control instruction for controlling the terminal apparatus, and (ii) for transmitting the control instruction to the terminal apparatus.

The foregoing arrangement makes it possible: to transmit, from the terminal apparatus to the control apparatus, request information for requesting screen data of an operation screen; to acquire, from the control apparatus, the screen data as a response to the request information; and to cause the display section of the terminal apparatus to display the operation screen that is based on the acquired screen data. With this, the terminal apparatus does not need to manage operation screen data of an operation screen, and only needs to request operation screen data of an operation from the control apparatus as needed. As a result, new control of the terminal apparatus can be developed without the need to incorporate operation screen data of an operation screen into the terminal apparatus. This improves efficiency in development of new control.

The foregoing arrangement enables the control apparatus to control the terminal apparatus in accordance with information inputted to the terminal apparatus.

Further, in addition to the foregoing arrangement, the control apparatus of the present invention may be arranged such that the request information accepting means and the screen data transmitting means receive and transmit the request information and the screen data, respectively, by a first communication method different from a second communication method by which the control instruction transmitting means transmits the control instruction. For example, the control apparatus of the present invention may be arranged such that the first communication method is HTTP or HTTPS and the second communication method is SOAP.

The foregoing arrangement makes it possible to adopt, as the first communication method, a communication method (e.g., HTTP) suitable for transmitting and receiving request information for requesting screen data and the screen data, and to adopt, as the second communication method, a communication method (e.g., SOAP) suitable for transmitting and receiving a control instruction.

HTTP has been typically used for communications between a client device and a service device, for the purpose of browsing through Web pages and the like. Using HTTP also for transmission of operation screen data of an operation screen makes it possible to easily construct the UI processing means, for example, by a general-purpose Web browser.

Further, HTTP has limitations in the processing contents of commands such as “get” and “put”. For this reason, as to the control instruction, the use of a communication method (communication protocol) such as SOAP makes it possible to perform various processes.

Further, the terminal apparatus may be arranged so as to be is a terminal apparatus that realizes an apparatus function by executing an appropriate combination of a plurality of elemental functions including an image reading function, an image forming function, and a communication function, the terminal apparatus including: elemental function executing means for executing the plurality of elemental functions; a command storage section in which a first control command for executing the apparatus function and a second control command acceptable to the elemental function executing means are stored so as to be associated with each other; control command converting means (i) for accepting a first control command, (ii) for specifying, from the command storage section, a second control command corresponding to the first control command, and (iii) for outputting the specified second control command to the elemental function executing means; control instruction accepting means for accepting a control instruction from the control apparatus via a communication network; and apparatus function control means (a) for creating, in accordance with the control instruction accepted by the control instruction accepting means, a first control command for executing the apparatus function, and (b) for sending the created first control command to the control command converting means. That is, the terminal apparatus may be a multifunctional apparatus that realizes an apparatus function by executing an appropriate combination of a plurality of elemental functions including an image reading function, an image forming function, and a communication function.

It should be noted here that examples of the elemental functions include a scan function, a print function, an image processing function, and a network function. Moreover, examples of the apparatus function that is realized by executing an appropriate combination of these elemental functions include: a copy function that is executed by a combination of the scan function, the image processing function, and the print function; and an image transmitting function that is executed by a combination of the scan function and the network function.

The elemental functions may vary depending on the type of terminal apparatus (multifunctional apparatus). For example, while a terminal apparatus A may include only the scanning function and the print function, a terminal apparatus B may include the copy function as an elemental function separately from those functions. In this case, the terminal apparatus A realizes the copy function as an elemental function by a combination of the scan function and the print function, whereas the terminal apparatus B only needs to execute the copy function as an elemental function. Further, different types of terminal apparatus may have different elemental function executing means for executing the same elemental function.

It is difficult to make the elemental functions common regardless of the type of terminal apparatus. This is because it is necessary to manufacture various types of terminal apparatus in accordance with users' needs. That is, a terminal apparatus usually includes elemental function executing means arranged so as to be unique to the terminal apparatus.

For the reasons set forth above, the second control command acceptable to the elemental function executing means varies depending on the type of terminal apparatus.

However, according to the foregoing arrangement, the control command converting means accepts the first control command, specifies, from the command storage section, the second control command corresponding to the first control command, and outputs the specified second control command to the elemental function executing means. With this, even when the second control command depends on the type of terminal apparatus as described above, the first control command acceptable to the control command converting means can be made independent of the type of terminal apparatus (i.e., can be made common to all terminal apparatuses).

With this, in cases where an external control apparatus controls a terminal apparatus, the control apparatus only needs to output, to the terminal apparatus, either a first control command independent of the type of terminal apparatus or a control instruction on which the first control command is based. As a result, it is only necessary to develop a control apparatus so that even in cases where the control apparatus performs new control with respect to a terminal apparatus, the control apparatus creates either a first control command common regardless of the type of terminal apparatus or a control instruction on which the first control command is based. This makes it easy to improve efficiency in development of the control apparatus.

Further, according to the foregoing arrangement, the apparatus function control means creates, in accordance with a control command, a first control command for executing the apparatus function, and sends the created first control command to the control command converting means. As described above, the first control command can be made common regardless of the type of terminal apparatus. Therefore, the apparatus function control means can also be arranged so as to be common regardless of the type of terminal apparatus. This improves efficiency in development of the terminal apparatus.

Further, in cases where an operation screen is used for controlling the apparatus function control means, such operation screens are made identical or similar regardless of the type of terminal apparatus. This is because the apparatus function control means do not depend on the type of terminal apparatus. As a result, users of different types of terminal apparatus operate identical operation screens. This improves user-friendliness.

Moreover, since the apparatus function control means does not depend on the type of terminal apparatus, the control instruction acceptable to the apparatus function control means also does not depend on the type of terminal apparatus. Therefore, the control apparatus only needs to output, to the terminal apparatus, a control command that does not depend on the type of terminal apparatus. As a result, it is only necessary to develop a control apparatus so that even in cases where the control apparatus performs new control with respect to a terminal apparatus, the control apparatus creates either a first control command common regardless of the type of terminal apparatus or a control instruction on which the first control command is based. This makes it easy to improve efficiency in development of the control apparatus.

Further, according to the foregoing arrangement, the terminal apparatus includes any one of such functions as described above. This makes it possible to improve user-friendliness of the terminal apparatus.

Further, in addition to the foregoing arrangement, the terminal apparatus of the present invention may be arranged so as to further include: a display section; and UI processing means for causing the display section to display an operation screen for the control apparatus to create the control instruction, wherein the UI processing means (i) transmits, to the control apparatus, request information for requesting screen data of the operation screen, (ii) acquires the screen data from the control apparatus as a response to the request information, (iii) causes the display section to display an operation screen that is based on the acquired screen data, and (iv) transmits, to the control apparatus, information inputted to the operation screen.

According to the foregoing arrangement, the UI processing means (i) transmits, to the control apparatus, request information for requesting screen data of the operation screen, (ii) acquires the screen data from the control apparatus as a response to the request information, and (iii) causes the display section to display an operation screen that is based on the acquired screen data. With this, the terminal apparatus does not need to manage operation screen data of an operation screen, and only needs to request operation screen data of an operation from the control apparatus as needed. As a result, new control of the terminal apparatus by the control apparatus can be developed without the need to incorporate operation screen data of an operation screen into the terminal apparatus. This further improves efficiency in development.

Then, the UI processing means transmits, to the control apparatus, information inputted to the operation screen. This enables the control apparatus to create a control instruction in accordance with the information inputted to the operation screen.

Further, in addition to the foregoing arrangement, the terminal apparatus of the present invention may be arranged such that the UI processing means transmits and receives the request information and the screen data by a first communication method different from a second communication method by which the control instruction accepting means receives the control instruction. For example, the terminal apparatus of the present invention may be arranged such that the first communication method is HTTP or HTTPS and the second communication method is SOAP.

The foregoing arrangement makes it possible to adopt, as the first communication method, a communication method (e.g., HTTP) suitable for transmitting and receiving request information for requesting screen data and the screen data, and to adopt, as the second communication method, a communication method (e.g., SOAP) suitable for transmitting and receiving a control instruction.

HTTP has been typically used for communications between a client device and a service device, for the purpose of browsing through Web pages and the like. Using HTTP also for transmission of operation screen data of an operation screen makes it possible to easily construct the UI processing means, for example, by a general-purpose Web browser.

Further, HTTP has limitations in the processing contents of commands such as “get” and “put”. For this reason, as to the control instruction, the use of a communication method (communication protocol) such as SOAP makes it possible to perform various processes.

Furthermore, in addition to the foregoing arrangement, the terminal apparatus of the present invention may be arranged such that: the UI processing means transmits, to the control apparatus, user information inputted to the operation screen; the control instruction accepting means accepts, as the control instruction, a validation/invalidation switching instruction to switch between validation and invalidation of each elemental function, the validation/invalidation switching instruction corresponding to the user information transmitted by the UI processing means; and the apparatus function control means creates, in accordance with the validation/invalidation switching instruction, a first control command for switching between the validation and invalidation of each elemental function.

In order to enable the terminal apparatus to perform a user authorization process, it has conventionally been necessary to incorporate, into the terminal apparatus, registration information, program, and the like, all of which are used for the user authentication process. In this case, since the terminal apparatus has other various arrangements, the arrangement for use in the user authentication process is limited (e.g., in terms of database capacity). This raises the possibility of a limitation to the number of registrations.

According to the foregoing arrangement, the UI processing means transmits, the control apparatus, request information for requesting screen data of an operation screen to which user information is inputted, and transmits user information inputted to the operation screen thus received. Then, the control instruction accepting means accepts, as the control instruction, a validation/invalidation switching instruction to switch between validation and invalidation of each elemental function, the validation/invalidation switching instruction corresponding to the user information transmitted by the UI processing means.

With this, simply by requesting, acquiring, and displaying an operation screen and transmitting the input user information, the terminal apparatus can receive an instruction to switch between the validation and invalidation of an elemental function corresponding to a user indicated by the user information. That is, the user authentication process is executed not in the terminal apparatus but in the control apparatus. This makes it unnecessary to incorporate, into the terminal apparatus, the arrangement for use in the user authentication process. The control apparatus is provided outside the terminal apparatus, and is not limited in terms of the arrangement for use in the user authorization process as with the terminal apparatus. This eliminates conventional problems such as limitation to the number of registrations.

Furthermore, in addition to the foregoing arrangement, the terminal apparatus of the present invention may be arranged so as to further include an operation screen identification information storage section in which, with respect to each of a plurality of such control instructions, operation screen identification information for identifying an operation screen for creating the control instruction is stored, wherein the UI processing means selects a single piece of operation screen identification information from the operation screen identification information storage section, and transmits request information for requesting screen data of an operation screen indicated by the selected operation screen identification information.

It should be noted here that examples of the operation screen identification information include a URL (uniform resource locator).

According to the foregoing arrangement, by designating operation screen identification information stored in the operation screen identification information storage section, the corresponding operation screen can be displayed by the display section, The operation screen identification information is designated, for example, by a user's input or by a command from an application. This makes it unnecessary for users and applications to input operation screen identification information to the UI processing means.

Furthermore, in addition to the foregoing arrangement, the terminal apparatus of the present invention may be arranged such that: the screen data contains (i) screen type information indicating a screen format of the operation screen and (ii) part type information indicating types of image parts that constitute the operation screen; the UI processing means includes a screen table storage section in which the screen type information and part display information indicating locations and display formats of the image parts in the operation screen, displayed by the operation panel 6, whose screen format is indicated by the screen type information, are stored so as to be correlated with each other; and the UI processing means reads out, from the screen table storage section, part display information corresponding to the screen type information contained in the operation screen data acquired from the control apparatus, creates an operation screen in accordance with the part display information and the part type information contained in the screen data acquired from the control apparatus, and causes the display section to display the operation screen.

The characteristics (e.g., size, resolution, color/monochrome, and font) of the display section of the terminal apparatus vary depending on the type of terminal apparatus.

According to the foregoing arrangement, the UI processing means (i) specifies part display information from screen type information on screen data, (ii) creates, in accordance with the part display information and part type information on the screen data, an operation screen suitable for the display section of the terminal apparatus, and (iii) causes the display section to display the operation screen. This allows the control apparatus to create, independently of the type of terminal apparatus, screen data containing the screen type information and part type information. This results in improved efficiency in development of the screen data.

Furthermore, in addition to the foregoing arrangement, the terminal apparatus of the present invention may be arranged so as to further include registration/editing means which, in response to a request sent from an external apparatus, stores new operation screen identification information in the operation screen identification information storage section and/or edits the operation screen identification information stored in the operation screen identification information storage section.

The foregoing arrangement enables an external apparatus to store new operation screen identification information in the operation screen identification information storage section, and to edit operation screen identification information stored in the operation screen identification information storage section.

Furthermore, in addition to the foregoing arrangement, the terminal apparatus of the present invention may be arranged so as to further include notifying means which, in response to a request sent from an external apparatus, notifies the external apparatus of the operation screen identification information stored in the operation screen identification information storage section.

The foregoing arrangement makes it possible to receive, from a terminal apparatus that has already been used, operation screen identification information registered in the terminal apparatus. This enables a user who has purchased a new terminal apparatus to acquire operation screen identification information from another terminal apparatus that has already been used, and to store the operation screen identification information in the newly-purchased terminal apparatus. As a result, the user can easily register the operation screen identification information in the newly-purchased terminal apparatus.

It should be noted that the control apparatus may be realized by computer. In this case, a program according to which the control apparatus is realized by computer by operating a computer as each of the means and a computer-readable storage medium in which the program is stored fall within the scope of the present invention. Similarly, the terminal apparatus may be realized by computer. In this case, a program according to which the terminal apparatus is realized by computer by operating a computer as each of the means and a computer-readable storage medium in which the program is stored fall within the scope of the present invention.

The present invention can be applied to a control apparatus that converts an online image into an image displayable by a display section of a terminal apparatus.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A control apparatus, including transmitting means for transmitting screen data to a terminal apparatus communicably connected to the control apparatus, which causes a display section of the terminal apparatus to display the screen data,
the control apparatus comprising:
data acquisition means for acquiring, from a server apparatus connected to a network, HTML data of a page available through the network; and
screen data creating means for creating the screen data by converting the HTML data into data displayable by the display section.

2. The control apparatus as set forth in claim 1, further comprising:
a screen data storage section in which general-purpose screen data to be displayed by the display section is stored; and
extracting means for extracting link information from the HTML data,
the link information containing (i) character string information associated with the link information and (ii) linked information for specifying a linked page, wherein
the screen data creating means (a) creates, as the screen image, an image obtained by pasting, on a part image contained in the general-purpose screen data or in a place adjacent to the part image contained in the general-purpose screen data, at least a part of a character string corresponding to the character string information contained in the link information extracted by the extracting means, and (b) stores the part image and the linked information in the screen data storage section so that the part image and the linked information are associated with each other.

3. The control apparatus as set forth in claim 1, further comprising a screen data storage section in which the screen data is stored, wherein
the screen data creating means stores the created screen data in the screen data storage section.

4. The control apparatus as set forth in claim 1, further comprising accepting means for accepting, from the terminal apparatus, information for specifying a page available through a network, wherein
the data acquisition means acquires HTML data of the page specified by the information accepted by the accepting means.

5. The control apparatus as set forth in claim 1, wherein the transmitting means (i) calculates, in accordance with communication speed data representing a speed of communication from the control apparatus to the terminal apparatus, a size of data transmittable per predetermined period of time, (ii) divides the screen data into pieces of data so that each of the pieces of data has a size of not larger than the calculated size, and (iii) transmits each of the pieces of data to the terminal apparatus.

6. The control apparatus as set forth in claim 1, further comprising:
request information accepting means for accepting, from the terminal apparatus, request information for requesting screen data of an operation screen;
screen data transmitting means for transmitting, to the terminal apparatus, the screen data corresponding to the request information accepted by the request information accepting means; and
control instruction transmitting means (i) for creating, in accordance with operation input information inputted to the operation screen corresponding to the screen data transmitted by the screen data transmitting means, a control instruction for controlling the terminal apparatus, and (ii) for transmitting the control instruction to the terminal apparatus.

7. The control apparatus as set forth in claim 6, wherein the request information accepting means and the screen data transmitting means receive and transmit the request information and the screen data, respectively, by a first communication method different from a second communication method by which the control instruction transmitting means transmits the control instruction.

8. The control apparatus as set forth in claim 7, wherein the first communication method is HTTP or HTTPS and the second communication method is SOAP.

9. A terminal apparatus including (i) receiving means for receiving screen data transmitted from a control apparatus and (ii) a display section for displaying the screen data,
the terminal apparatus comprising:
accepting means for accepting an instruction to select a part image contained in a display screen displaying the screen data; and
transmitting means for transmitting, to the control apparatus, information for specifying the selected part image.

10. The terminal apparatus as set forth in claim 9, further comprising:
designated page accepting means for accepting, from a user, designation of a desired page available through a network; and
transmitting means for transmitting, to the control apparatus, information for specifying the designated page.

11. The terminal apparatus as set forth in claim 9, wherein the receiving means receives pieces of data obtained by dividing the screen data and transmitted from the control apparatus,
the terminal apparatus further comprising combining means for restoring the original screen data by combining the pieces of data with one another,
the terminal apparatus causing the display section to display the restored screen data.

12. The terminal apparatus as set forth in claim 9, wherein the terminal apparatus accomplishes an apparatus function by executing an appropriate combination of a plurality of elemental functions including an image reading function, an image forming function, and a communication function,
the terminal apparatus comprising:
elemental function executing means for executing the plurality of elemental functions;
a command storage section in which a first control command for executing the apparatus function and a second control command acceptable to the elemental function executing means are stored so as to be correlated with each other;
control command converting means (i) for accepting a first control command, (ii) for specifying, from the command storage section, a second control command corresponding to the first control command, and (iii) for outputting the specified second control command to the elemental function executing means;
control instruction accepting means for accepting a control instruction from the control apparatus via a communication network; and
apparatus function control means (a) for creating, in accordance with the control instruction accepted by the control instruction accepting means, a first control command for executing the apparatus function, and (b) for sending the created first control command to the control command converting means.

13. The terminal apparatus as set forth in claim 12, further comprising:
a display section; and
UI processing means for causing the display section to display an operation screen for the control apparatus to create the control instruction, wherein
the UI processing means (i) transmits, to the control apparatus, request information for requesting screen data of the operation screen, (ii) acquires the screen data from the control apparatus as a response to the request information, (iii) causes the display section to display an operation screen that is based on the acquired screen data, and (iv) transmits, to the control apparatus, information inputted to the operation screen.

14. The terminal apparatus as set froth in claim 13, wherein the UI processing means transmits and receives the request information and the screen data by a first communication method different from a second communication method by which the control instruction accepting means receives the control instruction.

15. The terminal apparatus as set forth in claim 14, wherein the first communication method is HTTP or HTTPS and the second communication method is SOAP.

16. The terminal apparatus as set forth in claim 13, wherein:
the UI processing means transmits, to the control apparatus, user information inputted to the operation screen;
the control instruction accepting means accepts, as the control instruction, a validation/invalidation switching instruction to switch between validation and invalidation of each elemental function, the validation/invalidation switching instruction corresponding to the user information transmitted by the UI processing means; and
the apparatus function control means creates, in accordance with the validation/invalidation switching instruction, a first control command for switching between the validation and invalidation of each elemental function.

17. The terminal apparatus as set forth in claim 13, further comprising an operation screen identification information storage section in which, with respect to each of a plurality of said control instruction, operation screen identification information for identifying an operation screen for creating the control instruction is stored, wherein
the UI processing means selects a single piece of operation screen identification information from the operation screen identification information storage section, and transmits request information for requesting screen data of an operation screen indicated by the selected operation screen identification information.

18. The terminal apparatus as set forth in claim 13, wherein:
the screen data contains (i) screen type information indicating a screen format of the operation screen and (ii) part type information indicating types of image parts that constitute the operation screen;
the UI processing means includes a screen table storage section in which (a) the screen type information and (b) part display information indicating locations and display formats of the image parts in the operation screen, displayed by the display section, whose screen format is indicated by the screen type information, are stored so as to be correlated with each other; and
the UI processing means reads out, from the screen table storage section, part display information corresponding to the screen type information contained in the operation screen data acquired from the control apparatus, creates an operation screen in accordance with the part display information and the part type information contained in the screen data acquired from the control apparatus, and causes the display section to display the operation screen.

19. The terminal apparatus as set forth in claim 17, further comprising registration/editing means which, in response to a request sent from an external apparatus, stores new operation screen identification information in the operation screen identification information storage section and/or edits the operation screen identification information stored in the operation screen identification information storage section.

20. The terminal apparatus as set forth in claim 19, further comprising notifying means which, in response to a request sent from an external apparatus, notifies the external apparatus of the operation screen identification information stored in the operation screen identification information storage section.

21. A display system having (i) a terminal apparatus that includes a display section and (ii) a control apparatus that transmits screen data to the terminal apparatus and causes the display section of the terminal apparatus to display the transmitted screen data,
the control apparatus comprising:
data acquisition means for acquiring, from a server apparatus connected to a network, HTML data of a page available through the network; and
screen data creating means for creating the screen data by converting the HTML data into data displayable by the display section,
the terminal apparatus comprising receiving means for receiving the screen data transmitted from the control apparatus,
the terminal apparatus causing the display section to display the received screen data.

22. The display system as set forth in claim 21, wherein:
the control apparatus includes transmitting means that (i) calculates, in accordance with communication speed data representing a speed of communication from the control apparatus to the terminal apparatus, a size of data transmittable per predetermined period of time, (ii) divides the screen data into pieces of data so that each of the pieces of data has a size of not larger than the calculated size, and (iii) transmits each of the pieces of data to the terminal apparatus; and
the terminal apparatus includes (a) receiving means for receiving each of the pieces of data transmitted from the control apparatus and (b) combining means for restoring the original screen data by combining the pieces of data with one another, and causes the display section to display the restored screen data.

23. A display method for use in a display system, having (i) a terminal apparatus that includes a display section and (ii) a control apparatus communicably connected to the terminal apparatus, which causes the display section to display screen data transmitted from the control apparatus to the terminal apparatus,
the display method comprising:
a data acquisition step in which the control apparatus acquires, from a server apparatus connected to a network, HTML data of a page available through the network;
a screen data creating step in which the control apparatus creates the screen data by converting the HTML data into data displayable by the display section;
a transmitting step in which the control apparatus transmits the created screen data to the terminal apparatus;
a receiving step in which the terminal apparatus receives the screen data transmitted from the control apparatus; and
a display step in which the terminal apparatus causes the display section to display the received screen data.

24. The display method as set forth in claim 23, further comprising:
a calculation step in which the control apparatus calculates, in accordance with communication speed data representing a speed of communication from the control apparatus to the terminal apparatus, a size of data transmittable per predetermined period of time;
a dividing step in which the control apparatus divides the screen data into pieces of data so that each of the pieces of data has a size of not larger than the calculated size;
a transmitting step in which the control apparatus transmits each of the pieces of data to the terminal apparatus;
a receiving step in which the terminal apparatus receives each of the pieces of data transmitted from the control apparatus;
a combining step in which the terminal apparatus restores the original screen data by combining the pieces of data with one another; and
a display step of causing the display section to display the restored screen data.
